(19) United States
(12) Patent Application Publication
(10) Pub. No.: US 2013/0027767 A1
(43) Pub. Date: Jan. 31, 2013

(54) OPTICAL FILM, SECURITY PRODUCT, AND AUTHENTICITY DETERMINATION METHOD

(71) Applicant: Shinichi MORISHIMA, Kanagawa (JP)

(72) Inventor: Shinichi MORISHIMA, Kanagawa (JP)

(73) Assignee: FUJIFILM CORPORATION, Tokyo (JP)

(21) Appl. No.: 13/555,849

(22) Filed: Jul. 23, 2012

(30) Foreign Application Priority Data
Jul. 26, 2011 (JP) 2011-163667

(51) Int. Cl. G02B 5/30; G02B 5/22; G06K 9/74

(52) U.S. Cl. 359/361; 356/71; 359/489.07

(57) ABSTRACT

The present invention provides an optical film with an excellent counterfeit prevention effect. The optical film of the present invention includes: a pattern optically anisotropic layer in which at least a first phase difference region, a second phase difference region, and a third phase difference region are arranged to be in proximity with one another within the same plane, wherein the in-plane slow axis direction is different for the first phase difference region and the third phase difference region, and in the second phase difference region, the slow axis direction is parallel to, and an in-plane retardation is different from, either the first phase difference region or the third phase difference region.

### BACKGROUND OF THE INVENTION

1. Field of the Invention

The present invention relates to an optical film that is used in a security product, a security product using the optical film, and an authenticity determination method.

2. Description of the Related Art

Valuables such as cash vouchers, securities, and prepaid cards and certificates such as certificates of title and ID cards can sustain a variety of losses through counterfeiting. Further, products such as computer software, music software, and video software which are to be protected by copyright are provided with a variety of schemes to prevent counterfeiting, alteration, and reproduction.

Methods of the related art of preventing counterfeiting for such ID cards, music software, and the like can be broadly categorized into the three types below.

A first method uses advanced printing techniques typified by watermarks, microprinting, and holograms, which are used on currency, gift certificates, stock certificates, credit cards, music CDs, and the like.

A second method prevents counterfeiting by recording encryption information on a magnetic recording medium, an IC, an optical recording medium, or the like, and is used on prepaid cards, passenger tickets, season tickets, and the like.

A third method is a method of deforming through physical force so that repair is not possible, such as through punch holes, and is used on telephone cards and the like.

Given such circumstances, using an optical film on security products is being investigated. For example, recording information, using and observing a polarizing film, and observing whether or not a product is genuine using an optical phase difference element that includes an oriented film and an optically anisotropic layer on a support, wherein the oriented film contains at least one type of compound with a photoreactive group and the optically anisotropic layer includes at least three types of regions with different fast axes or slow axes is disclosed in JP2007-25202A.

### SUMMARY OF THE INVENTION

However, with the security products described above, dichroic pigments are needed. An object of the present invention is to provide a security product that can be identified without such dichroic pigments. Further, another object of the present invention is to provide an optical film that can be used by such a security product or a product that requires adjustment light.

Given such circumstances, as a result of the present inventors conducting intensive studies, it was found that the problems described above are solved by (1), (15), (16), and (18) below. Even more preferably, the problems were solved by (2) to (14) and (17) below.

(1) An optical film including: a pattern optically anisotropic layer including at least a first phase difference region, a second phase difference region, and a third phase difference region, wherein the at least first phase difference region, second phase difference region, and third phase difference region are arranged so that the same phase difference regions do not continue within the same plane, that is, the at least first phase difference region, second phase difference region, and third phase difference region are arranged in proximity with one another on the same plane, an in-plane slow axis direction is different for the first phase difference region and the third phase difference region, and in the second phase difference region, the slow axis direction is parallel to, and the in-plane retardation is different from, either the first phase difference region or the third phase difference region.

(2) The optical film according to (1), further including: a polarizing film.

(3) The optical film according to (1) or (2), wherein the pattern optically anisotropic layer is formed on a transparent support with an in-plane retardation Re (550) of 0 to 10 nm with a wavelength of 550 nm is.

(4) The optical film according to any of (1) to (3), wherein the at least first phase difference region, second phase difference region, and third phase difference region are formed with a striped pattern.

(5) The optical film according to (2) and according to (3) and (4) according to (2), wherein the extending direction of the at least first phase difference region, second phase difference region, and third phase difference region with the striped pattern and an absorption axis of the polarizing film are parallel or orthogonal.

(6) The optical film according to any one of (2) to (5), wherein the in-plane slow axis of the first phase difference region, the second phase difference region, and the third phase difference region and the absorption axis of the polarizing film respectively form an angle of ±45°.

(7) The optical film according to any of (1) to (6), wherein the in-plane retardations Re (550) with a wavelength of 550 nm of the first phase difference region and the third phase difference region are respectively 100 to 190 nm.

(8) The optical film according to any of (1) to (7), wherein the in-plane retardation Re (550) with a wavelength of 550 nm of the second phase difference region is 50 to 150 nm.

(9) The optical film according to any of (1) to (8), wherein the Re (550) of the second phase difference region and the slow axis direction of the second phase difference region are parallel, and the difference between Re's (550) of phase difference regions with different in-plane retardations is equal to or greater than 20 nm.

(10) The optical film according to any of (1) to (9), wherein any layer that configures the optical film contains an ultraviolet absorber.

(11) The optical film according to any one of (1) to (10), wherein the first phase difference region, the second phase difference region, and the third phase difference region are respectively formed of a composition that includes a discotic liquid crystal compound with a polymerizable group.

(12) The optical film according to (11), wherein in at least one region of the first phase difference region, the second phase difference region, and the third phase difference region, the orientation of the discotic liquid crystal is fixed to a vertical orientation state.

(13) The optical film according to any of (1) to (12), wherein the pattern optically anisotropic layer is formed on an oriented film that is orientated in one direction.

(14) The optical film according to (13), wherein the oriented film is a rubbing oriented film that is rubbed in one direction.

(15) A pair of polarizing films including two of the optical films according to any of (1) to (14).

(16) A security product that uses the optical film according to any of (1) to (14).

(17) A security product that includes at least two of the optical films according to any of (1) to (14) on one face or both faces of a transparent support, wherein out of the at least two optical films, at least one optical film is movable, and a light transmission amount can be adjusted according to the movement of the movable optical film.

(18) An authenticity determination method which determines that a product that includes the security product according to (16) or (17) is genuine by using and observing a polarizing film.

According to the present invention, a security product with high identification ability can be provided. Further, an optical film that can be used for various products that require modulated light can be provided.

### BRIEF DESCRIPTION OF THE DRAWINGS

FIG. 1 is an upper view that illustrates an example of a pattern optically anisotropic layer according to the present invention.

FIG. 2 is an upper view that illustrates an example of a pattern optically anisotropic layer according to the present invention.

FIG. 3 is an upper view that illustrates another example of a pattern optically anisotropic layer according to the present invention.

FIG. 4 is a cross-sectional view that illustrates an example of an optical film of the present invention.

FIG. 5 is an outline view that illustrates an example of the relationship between a polarizing film and the pattern optically anisotropic layer according to the present invention.

FIG. 6 is an outline view that illustrates an example of an embodiment in a case when two optical films of the present invention are used in combination.

FIGS. 7A and 7B are outline views that illustrate the states before and after the pattern optically anisotropic layer is slid in a case when two optical films of the present invention are used in combination.

FIGS. 8A and 8B are outline views that illustrate the position of a mask for creating an oriented film and the direction of an absorption axis of a wire grid polarizer according to Example 4.

FIG. 9 is an outline view that illustrates the position of a mask for creating the optically anisotropic layer according to Example 4.

### DESCRIPTION OF THE PREFERRED EMBODIMENTS

Details of the present invention will be described below. Here, in the present specification, ranges of numerical values expressed using “to” signify ranges that include the numerical values before and after the “to” as the lower limit value and the upper limit value.

In the present specification, in a case when a measurement wavelength is not particularly noted, the measurement wavelength is 550 nm.

Further, in the present specification, angles (angles such as, for example, “90°”) and the relationships therebetween (for example, “orthogonal”, “parallel”, “intersect at 45°”, and the like) are within margins of error which are accepted in the technical field of the present invention. For example, the range is less than ±10° of a strict angle, wherein the error from the strict angle is preferably equal to or less than 5° and even more preferably equal to or less than 3°.

[Re and Rth]

In the present specification, Re (λ) and Rth (λ) respectively represent the in-plane retardation and the retardation in the thickness direction of a wavelength λ. Re (λ) is measured by causing light with a wavelength of λ nm to be incident on a KOBRA 21ADH or WR (manufactured by Oji Scientific Instruments Co., Ltd.) in a film normal vector direction. In selecting the measurement wavelength nm, measurement can be performed by manually converting a wavelength selection filter or converting the measurement values using a program or the like.

In a case when the film that is measured is represented by a single-axis or double-axis index ellipsoid, Rth (λ) is calculated by the method below.

The KOBRA 21ADH or WR calculates Rth (λ) by causing light with a wavelength of λ nm to be incident from each inclined direction with respect to the film normal vector direction with steps of 10 degrees from the normal vector direction to 50 degrees to one side with the slow axis (determined by the KOBRA 21ADH or WR) within a plane as an inclined axis (rotation axis) (in a case when there is no slow axis, an arbitrary direction within the film face is the rotation axis), measuring a total of six points, and basing the calculation of Rth (λ) on the measured retardation values, an assumed value of the average refractive index, and the input film thickness value.

In the description above, in the case of a film with a direction in which the retardation value is zero at a certain inclination angle from the in-plane slow axis with the normal vector direction as the rotation axis, the KOBRA 21ADH or WR calculates a retardation value at a greater inclination angle than such an inclination angle after changing the sign of the retardation value to negative.

Here, Rth (λ) may be calculated by Formulae 11 and 12 below by measuring retardation values from two arbitrary inclined angles and basing Rth (λ) on such values, the assumed values of the average refractive index, and the input film thickness values with the slow axis as the inclination axis (rotation axis) (in a case when there is no slow axis, an arbitrary direction within the film face is the rotation axis).

Formula 11

$$Re ( θ ) = [ nx - \frac{ny \times nz}{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}} ] \times \frac{d}{cos \{ {sin}^{- 1} ( \frac{sin ( - θ )}{nx} ) \}} \qquad [ Equation 1 ]$$

Re (θ) above represents a retardation value in a direction that is inclined by an angle θ from the normal vector direction.

In Formula 11, nx represents the refractive index in the slow axis direction within the plane, ny represents the refractive index in a direction that is orthogonal to nx within the plane, and nz represents the refractive index of a direction that is orthogonal to nx and ny. d is the film thickness.

Rth={(nx+ny)/2−nz}×d Formula 12:

In Formula 12, nx represents the refractive index in the slow axis direction within the plane, ny represents the refractive index in a direction that is orthogonal to nx within the plane, and nz represents the refractive index of a direction that is orthogonal to nz and ny. d is the film thickness.

In a case when the film to be measured cannot be expressed as a single-axis or double-axis index ellipsoid, that is, in the case of a film without an optical axis, Rth (λ) is calculated by the method below.

The KOBRA 21ADH or WR calculates Rth (λ) by causing light with a wavelength of λ nm to be incident from each inclined direction with respect to the film normal vector direction with steps of 10 degrees from −50 degrees to +50 degrees with the slow axis (determined by the KOBTA 21ADH or WR) within a plane as an inclined axis (rotation axis), measuring eleven points, and basing the calculation of Rth (λ) on the measured retardation values, an assumed value of the average refractive index, and the input film thickness value.

In the measurement described above, the assumed values of the average refractive index may use the values from Polymer Handbook (JOHN WILEY & SONS; INC.) and the catalog values of various optical films. When the value of an average refractive index is not known, the value may be measured using an Abbe refractometer. The values of the average refractive index of the main optical films are shown here: cellulose acylate (1.48), cycloolefin polymer (1.52), polycarbonate (1.59), polymethylmethacrylate (1.49), and polystyrene (1.59). The KOBRA 21ADH or WR calculates nx, ny, and nz by inputting assumed values of the average refractive indices and the film thickness. Nz=(nx-nz)/(nx-ny) is further calculated from the calculated nx, ny, and nz.

An optical film of the present invention includes a pattern optically anisotropic layer in which at least a first phase difference region, a second phase difference region, and a third phase difference region are arranged so that the same phase difference regions do not continue within the same plane, the in-plane slow axis direction is different for the first phase difference region and the third phase difference region, and in the second phase difference region, the slow axis direction is parallel to, and the in-plane retardation is different from, either the first phase difference region or the third phase difference region. By adopting such means, an even film can be recognized even when observed in natural light, while when a polarizing film is used and the absorption axis of the polarizing film and the absorption axis of a polarizing film that the optical film includes are orthogonal, the image can be verified with high contrast.

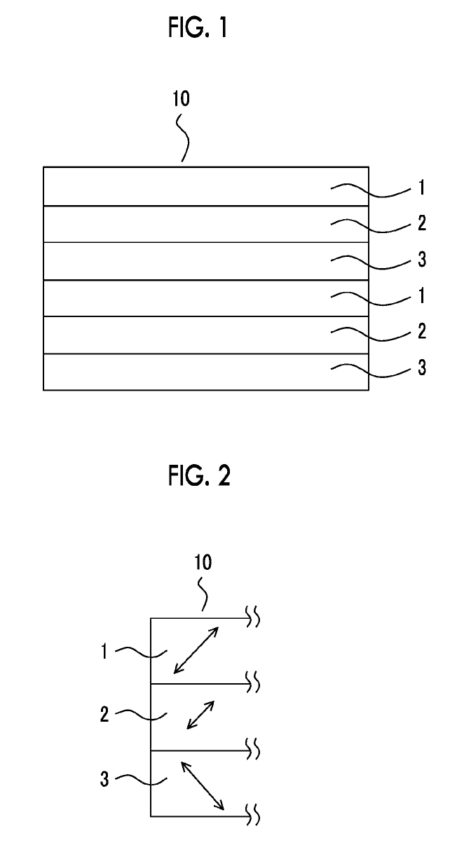

The optical film of the present invention will be described in detail below. FIG. 1 is an upper view that illustrates an example of a pattern optically anisotropic layer 10 of the present invention, and 1 indicates a first phase difference region, 2 indicates a second phase difference region, and 3 indicates a third phase difference region. In the present embodiment, while only the first to third phase difference regions are provided, needless to say, a fourth phase difference region may also be provided. It is preferable that the phase difference regions have the same shapes as one another. Further, it is preferable that the respective arrangements be even. While the pattern optically anisotropic layer according to the present embodiment has a structure in which the first phase difference region, the second phase difference region, and the third phase difference region are respectively alternately arranged in that order in a striped pattern, the structure is not limited to the striped pattern. Further, in the present embodiment, the stripes may be formed in the longitudinal direction of the optical film, or may be formed in a direction that is perpendicular to the longitudinal direction.

Further, the widths (borders) between the first phase difference region, the second phase difference region, and the third phase difference region are preferably 1 to 100 μm, and more preferably 5 to 20 μm.

In the present invention, the in-plane slow axis direction is different for the first phase difference region and the third phase difference region. FIG. 2 is an outline view that illustrates the direction of the in-plane slow axis in the pattern optically anisotropic layer of the present invention, wherein each symbol is in common with FIG. 1 (the same is true of drawings below). The arrow indicates the in-plane slow axis direction. As illustrated in FIG. 2, the in-plane slow axis direction is different for the first phase difference region and the third phase difference region. The in-plane slow axis directions of the first phase difference region and the third phase difference region preferably have an angle difference of 70 to 110°, more preferably an angle difference of 80 to 100°, and even more preferably an angle difference of 90°.

It is preferable that the in-plane slow axis directions of the first phase difference region and the third phase difference be respectively ±45° with respect to an arbitrary side (preferably a stripe that is formed by the phase difference regions) of the optical film.

In-plane retardations Re's (550) of the first phase difference region and the third phase difference region with a wavelength of 550 nm are preferably 100 to 190 nm, more preferably 120 to 170 nm, and even more preferably 125 to 140 nm. Further, the difference between the Re's (550) of the first phase difference region and the third phase difference region is preferably equal to or less than 30 nm, more preferably equal to or less than 10 nm, and even more preferably equal to or less than 4 nm. By adopting such a configuration, the contrast between the first phase difference region and the third phase difference region can be increased.

In the second phase difference region, the in-plane slow axis direction is parallel to, and the in-plane retardation is different from, either the first phase difference region or the third phase difference region. For example, in FIG. 2, the second phase difference region has a slow axis that is parallel to the first phase difference region and the in-plane retardation is small.

The in-plane retardation Re (550) of the second phase difference region with a wavelength of 550 nm is preferably 50 to 150 nm and more preferably 60 to 120 nm.

Further, it is preferable that the difference between the in-plane retardation Re (550) of the second phase difference region and, out of the first phase difference region and the third phase difference region, the in-plane retardation Re (550) of the phase difference region with a slow axis direction that is parallel (the first phase difference region in FIG. 2) be equal to or greater than 20 nm, more preferably 40 to 100 nm, and even more preferably 60 to 80 nm. By adopting such a configuration, the contrast tends to be clearer.

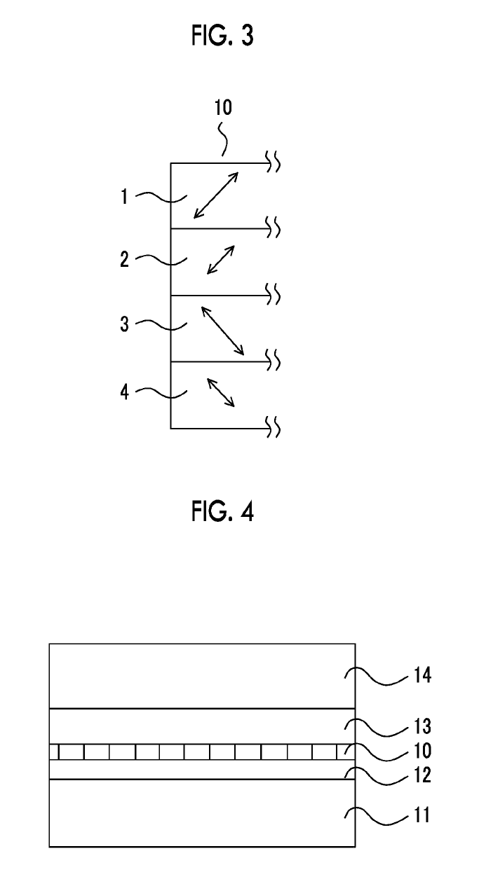

The optically anisotropic layer in the present invention may have a fourth phase difference region as illustrated in FIG. 3.

It is preferable that in the fourth phase difference region, the slow axis direction be parallel to, and the in-plane retardation be different from, the phase difference region, out of the first phase difference region and the third phase difference region, in which the slow axis direction is not parallel with the second phase difference region. In FIG. 4, the fourth phase difference region has an in-plane slow axis direction that is parallel to, and an in-plane retardation that is different from, the third phase difference region.

The in-plane retardation Re (550) of the fourth phase difference region with a wavelength of 550 nm is preferably 50 to 150 nm and more preferably 60 to 120 nm.

It is preferable that the difference between the in-plane retardation Re (550). of the fourth phase difference region and that of the phase difference region with a slow axis direction that is parallel (the third phase difference region in the case of FIG. 3) be equal to or greater than 20 nm, more preferably 40 to 100 nm, and even more preferably 60 to 80 nm. By adopting such a configuration, the contrast tends to be clearer.

The optical film of the present invention preferably includes a polarizing film. FIG. 4 is a cross-sectional outline view that illustrates an example of a state in which the optical film of the present invention includes a polarizing film. In FIG. 4, 13 indicates a polarizing film, 10 indicates a pattern optically anisotropic layer, 11 indicates a transparent support, 12 indicates an oriented film, 13 indicates a polarizing film, and 14 indicates a polarizing film protective film. In such a manner, by providing a polarizing film, for example, by holding a polarizing plate and observing from the transparent support 11 side, a variety of patterns that correspond to the pattern optically anisotropic layer 10 can be observed.

The transparent support 11 is usually a polymer film, and a film with a small birefringence is preferable. By adopting such a film, the pattern of the pattern optically anisotropic layer 10 can be accurately recreated without being influenced by the birefringence of the transparent support.

The oriented film 12 is provided to orient a liquid crystal compound in a case when a liquid crystal compound is used for the pattern optically anisotropic layer 10. Therefore, depending on the formation method of the pattern optically anisotropic layer 10, there may be a case when the oriented film 12 is unnecessary.

The polarizing film protective film 14 in the present embodiment is provided only on one face of the polarizing film 13. This is because in the present embodiment, the pattern optically anisotropic layer 10 performs the role of the other polarizing film protective film. Naturally, needless to say, a polarizing film protective film may be provided on the other face of the polarizing film 13.

Furthermore, although not shown, needless to say, constituent layers of adhesive layers and the like may be included.

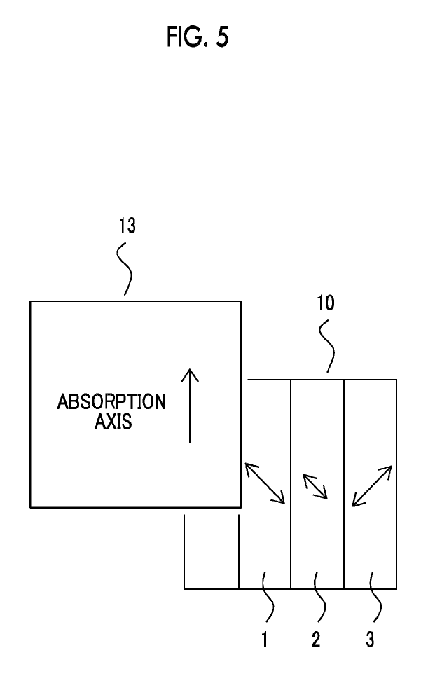

In the present invention, it is preferable that the in-plane slow axes of the first phase difference region, the second phase difference region, and the third phase difference region and the absorption axis of the polarizing film 13 respectively form an angle of ±45°. FIG. 5 illustrates the relationship between the absorption axis of the polarizing film 13 and the in-plane slow axes of the optically anisotropic layer 10, wherein the absorption axis of the polarizing film 13 and the in-plane slow axes of the optically anisotropic layer 10 respectively form an angle of ±45°.

Further, in a case when two optical films of the present invention are combined, it is preferable that the absorption axis of the polarizing film of one optical film be set to be orthogonal to the stripes, and the absorption axis of the polarizing film of the other optical film be set to be parallel to the stripes. Details will be described later.

Preferable materials, manufacturing methods, and the like of the constituent layers of the present invention will be described below. Needless to say, the optical film of the present invention is not limited to those below.

<Pattern Optically Anisotropic Layer>

In the pattern optically anisotropic layer of the present invention, it is preferable to form each phase difference region using a liquid crystal composition (preferably a composition that includes a discotic liquid crystal compound), it is preferable to form each phase difference region using the same curing liquid crystal composition with liquid crystal as the principal component, and it is preferable to form each phase difference region through pattern exposure.

More specifically, a first aspect of forming the pattern optically anisotropic layer is a method of using a plurality of effects that influence the orientation control of the liquid crystal and making a predetermined control effect dominant after causing any of the effects to disappear through external stimulation (heating process or the like). For example, after one phase difference region is formed by making the liquid crystal have a predetermined orientation state through the combined effect of an orientation control ability by the oriented film and the orientation control ability of an orientation control agent that is added to the liquid crystal composition and fixing the orientation state, another phase difference region is formed by causing any of the effects (for example, the effect due to the orientation control agent) to disappear through external stimulation (heating process or the like), making another orientation control effect (the effect due to the oriented film) dominant, and thereby realizing another orientation state. For example, since a pyridinium group or an imidazolium group is hydrophilic, a predetermined pyridinium compound or imidazolium compound is unevenly distributed on a hydrophilic polyvinyl alcohol oriented film surface. In particular, if a pyridinium group and furthermore, if an amino group that is a hydrogen-atom accepting substituent is substituted, an intermolecular hydrogen bond is created between the substituted group and the polyvinyl alcohol and the compound is unevenly distributed on the oriented film surface with greater density, and due to the effect of the hydrogen bonds, since a pyridinium derivative is oriented in a direction that is orthogonal to the main chain of the polyvinyl alcohol, the orthogonal orientation of the liquid crystal with respect to the rubbing direction is promoted. Since the pyridinium derivative has a plurality of aromatic rings in the molecule, a strong intermolecular π-π interaction is caused between the liquid crystal molecules, in particular the discotic liquid crystal molecules described above, and the orthogonal orientation of the discotic liquid crystal in the vicinity of the oriented film interface is induced. In particular, if a hydrophobic aromatic group is coupled with the hydrophilic pyridinium group, there is also an effect of inducing vertical orientation through the hydrophilic effect. However, as a result, if heating exceeds a certain temperature, the hydrogen bonds are broken, the density of the pyridinium compound or the like on the oriented film surface decreases, creating a horizontal orientation state. As a result, the liquid crystal is oriented by the regulating force of the rubbing oriented film itself, and the liquid crystal adopts a horizontal orientation state. Details of such a method are described in JP2010-141345, and the content thereof is incorporated by reference in the present specification.

A second aspect of forming the pattern optically anisotropic layer is an aspect that uses pattern oriented films. According to the aspect, the liquid crystal is oriented by forming pattern oriented films with respectively different orientation control abilities and arranging a liquid crystal composition thereon. The orientation of the liquid crystal is regulated by the respective orientation control abilities of the pattern orientation films, thereby achieving orientation states that are different from one another. By fixing the respective orientation states, patterns of phase difference regions according to the patterns of the oriented films are formed. The pattern oriented films can be formed using a printing method, mask rubbing on a rubbing oriented film, mask exposure on an optically oriented film, or the like. Further, a pattern oriented film may also be formed by forming an oriented film uniformly and printing an additive (for example, the onium salt described above or the like) that influences the orientation control ability with a separate and predetermined pattern. A method that uses the printing method is preferable from the viewpoint that a large-scale facility is not necessary and from the viewpoint of ease of manufacture. Details of such a method are described in JP2010-173077, and the content thereof is incorporated by reference in the present specification.

Further, the first and second aspects described above may be used together. One example is an example of adding a photoacid generator to the oriented film. In the example, three or more phase difference regions can be formed through half exposure that is realized by adding a photoacid generator to the oriented film and changing the on and off states of the exposure amount (exposure strength) as well as the exposure amount.

That is, through the pattern exposure, a region in which the photoacid generator disintegrates and an acidic compound is generated, a region in which a portion of the photoacid generator disintegrates and an acidic compound is generated, and a region in which the photoacid generator does not disintegrate and an acidic compound is not generated are formed. The photoacid generator remains mostly not disintegrated at portions of no light exposure, an interaction between the oriented film material, the liquid crystal, and an oriented film control agent that is added as desired dominates the orientation state, and the liquid crystal is oriented in a direction in which the slow axis thereof is orthogonal to the rubbing direction. When light is irradiated on the oriented film and an acidic compound is generated, the interaction ceases to be dominant, the rubbing direction of the rubbing oriented film dominates the orientation state, and the liquid crystal is horizontally oriented with the slow axis thereof parallel with the rubbing direction. A water-soluble compound is preferably used as the photoacid generation agent that is used as the oriented film. Details of such a method are described in JP2010-289360, and the content thereof is incorporated by reference in the present specification.

The rubbing oriented film exhibits an orientation control ability through a rubbing process. Normally, when liquid crystal is oriented on an oriented film that is rubbing processed in one direction, the liquid crystal is oriented with the slow axis thereof parallel or orthogonal to the rubbing direction. The orientation state is determined by one or more of the oriented film material, the liquid crystal, and the orientation control agent, or the like. In the present invention, an orientation state in which the slow axis of the liquid crystal is orthogonally oriented with respect to the rubbing direction and an orientation state in which the slow axis of the liquid crystal is oriented to be parallel with respect to the rubbing direction are respectively realized by one or both of disintegrating the oriented film material and changing the oriented film interface uneven distribution of the orientation control agent through the effect of the acidic compound which is generated by the irradiation of ultraviolet rays on the oriented film. The shape and arrangement of each phase difference region can be the desired shape and pattern of arrangement by selecting a photomask. With an aspect that is used in an image display device for stereoscopic image display, it is preferable that each phase difference region is strip-like with the length of the short length of each being approximately equal and be repeatedly alternately patterned.

A water-soluble compound is preferably used as the photoacid generator that is used for the oriented film. Examples of the photoacid generator that can be used include the compound described in Prog. Polym. Sci., volume 23, page 1485 (1998).

A pyridinium salt, an iodonium salt, and a sulfonium salt are particularly preferably used as the photoacid generator. The salts represented by the general formulae below are respectively exemplified as preferable examples of a pyridinium salt, an iodonium salt, and a sulfonium salt.

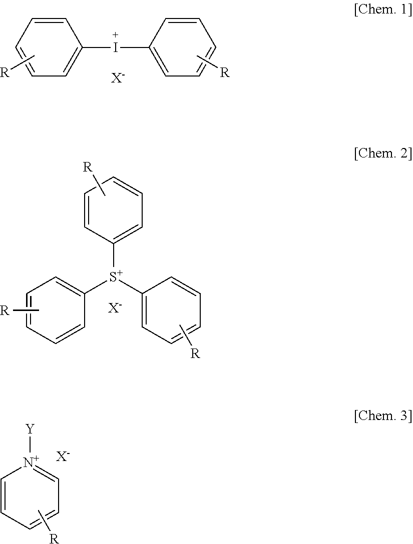

In the formulae, R is respectively a hydrogen atom, a straight-chain alkyl group or a branched alkyl group with one to six carbon atoms, a straight-chain alkoxy group or a branched alkoxy group with one to six carbon atoms, an aryl group with six to twelve carbon atoms, or a halogen atom. Y is a straight-chain alkyl group or a branched alkyl group with one to six carbon atoms, or a straight-chain alkoxy group or a branched alkoxy group with one to six carbon atoms. X— represents a pair of anions of a pyridinium salt, an iodonium salt, or a sulfonium salt, and are anions of an acidic compound that is created through disintegration. The anions are preferably PF6⁻ or BF₄⁻. For example, the acid HBF₄ is generated through disintegration from a photoacid generator in which X— is BF₄⁻, and the acid HPF₆ is generated from a photoacid generator in which X— is PF6⁻.

While specific examples of photoacid generators that can be used in the invention are shown below, the invention is not limited thereto.

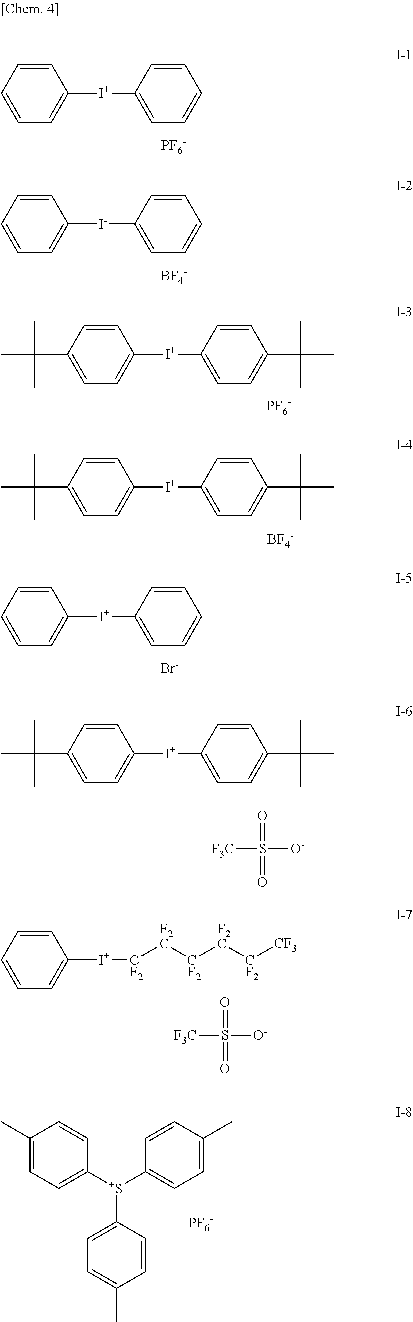

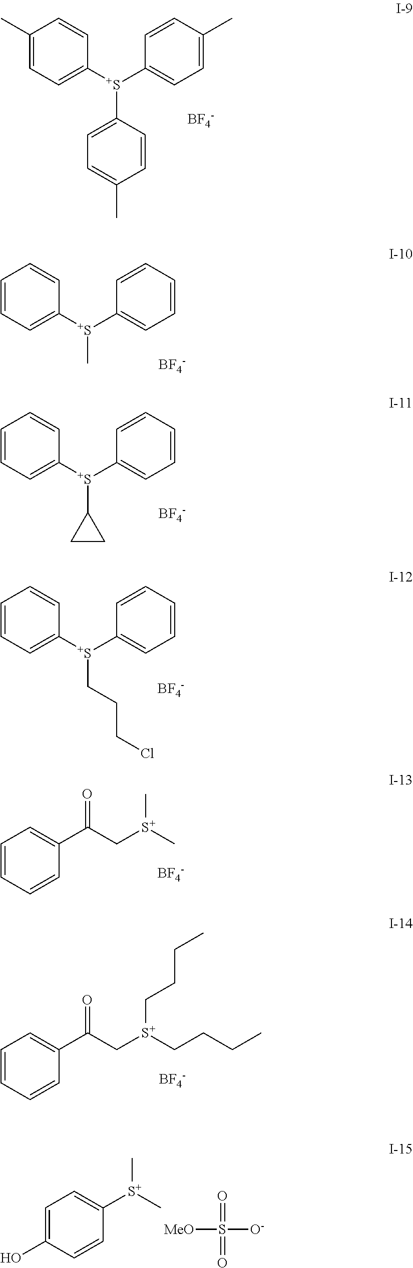

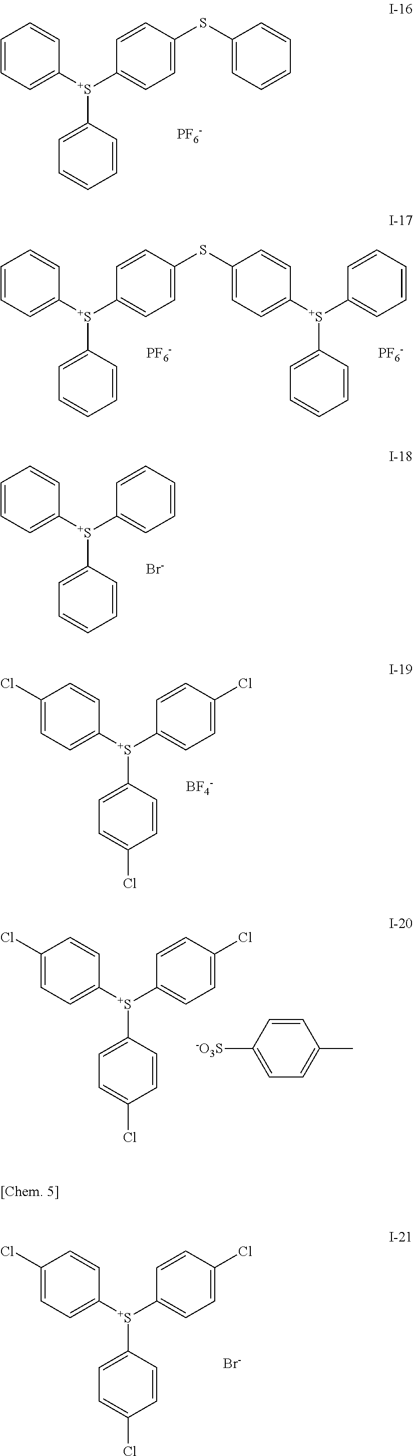

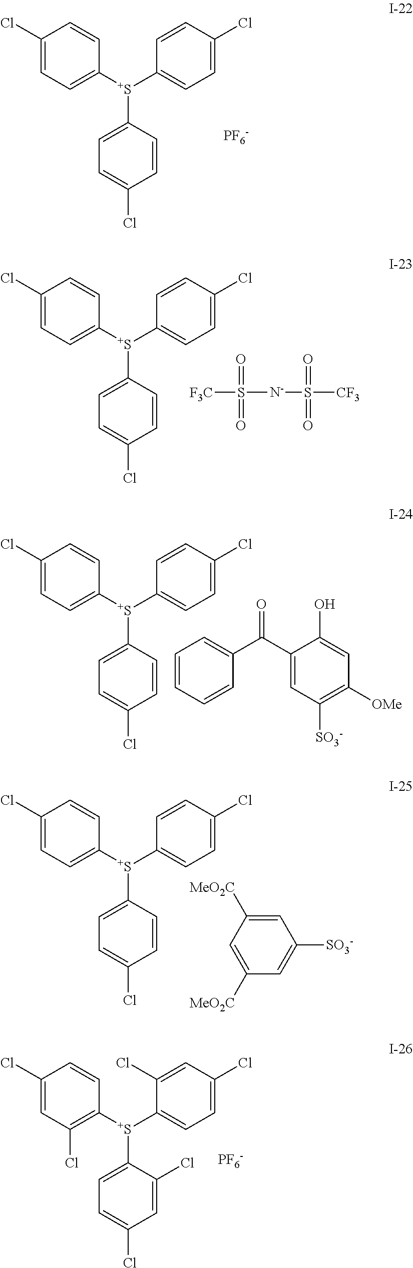

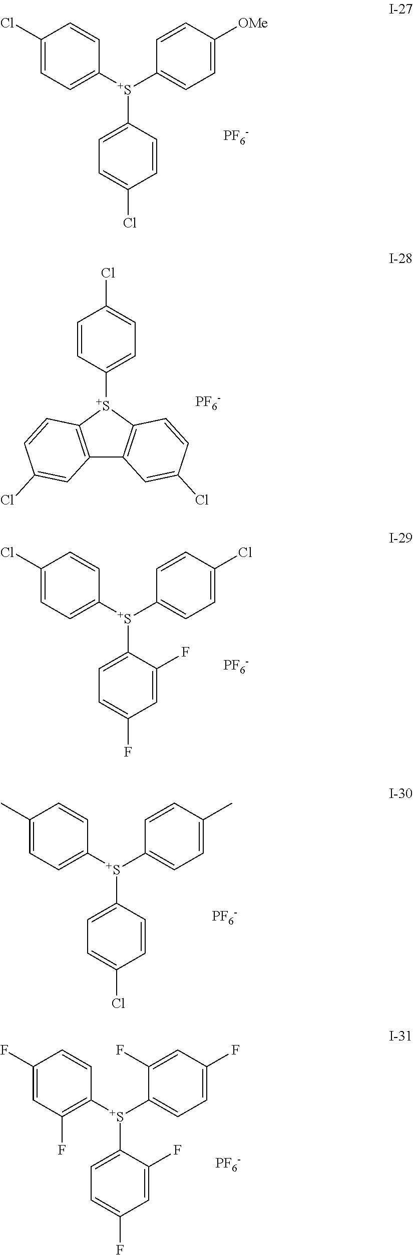

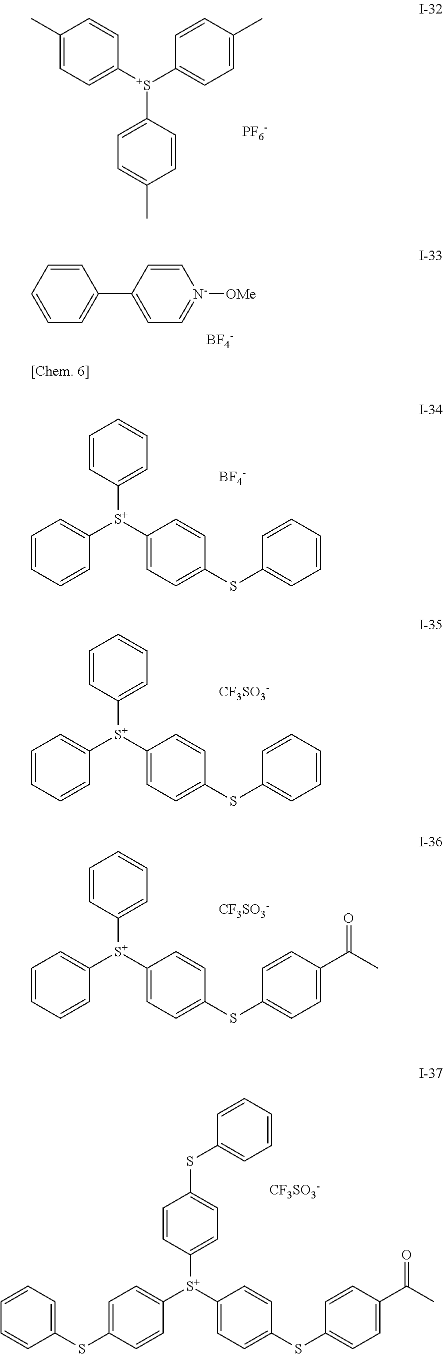

It is preferable that the composition that is used in the formation of the oriented film be prepared as a coating liquid. The solvent that is used in the preparation of the coating preferably contains water, more preferably contains water at equal to or greater than 20 mass %, and even more preferably includes water at 50 to 80 mass %. By using a coating liquid that is prepared using a water-containing solvent, when being applied on the support, elution of the support due to the solvent can be suppressed or controlled.

The content amount of each component within the oriented film composition can be set as appropriate to form a stable oriented film. For example, the content amount of the oriented film polymer material that is the principal component can be 2.0 to 10.0 mass % with respect to the total amount of the composition (including the solvent), and preferably 2.0 to 5.0 mass %. The addition amount of the photoacid generator can be set as appropriate within a range with which ion exchange is possible with the pair of anions of onium salt described above, and for example, can be 0.1 to 10.0 mass % with respect to the oriented film polymer material or preferably 0.5 to 5.0 mass %. Further, the solvent amount within the composition can be, for example, 80 to 98 mass % with respect to the total amount of the composition or preferably 90 to 97 mass %.

One example of the composition that is used in the formation of the optically anisotropic layer is a liquid crystal composition that contains at least one type of liquid crystal compound that includes a polymerizable group and at least one type of an orientation control agent. Otherwise, a polymerization initiator and a sensitizer may be contained.

Each material will be described in detail below.

[Liquid Crystal Compound with Polymerizable Group]

A rod-like liquid crystal and a discotic liquid crystal can be exemplified as liquid crystals that can be used as the principal raw material of the optically anisotropic layer of the present invention, wherein a discotic liquid crystal is preferable and a discotic liquid crystal that includes a polymerizable group as described above are more preferable.

A compound selected from those described in various gazettes and specifications such as, for example, Makromol. Chem., volume 190, page 2255 (1989), Advanced Materials volume 5, page 107 (1993), U.S. Pat. No. 4,683,327A, U.S. Pat. No. 5,622,648A, U.S. Pat. No. 5,770,107A, WO95/22586A, WO95/24455A, WO97/00600A, WO98/23580A, and WO98/52905A, JP1989-272551A (JP-H01-272551A), JP 1994-16616A (JP-H06-16616A), JP 1995-110469A (JP-H07-110469A), JP1999-80081A (JP-H1′-80081A), and JP1999-513019A (JP-H11-513019A), and JP2001-64627 can be used.

The compound represented by General Formula X below is preferable as the rod-like liquid crystal compound.

Q¹-L¹-Cy¹-L²-(Cy²-L⁻)ₙ-Cy³L⁴-Q² General Formula X

In the formula, Q¹ and Q² each independently represent a polymerizable group, L¹ and L⁴ each independently represent a divalent linked group, L² and L³ each independently represent a single bond or a divalent linked group, Cy¹, Cy², and Cy³ each independently represent a divalent cyclic group, and n is 0, 1 or 2.

In the formula, Q¹ and Q² are each independently a polymerizable group. It is preferable that the polymerization reaction of the polymerizable groups be addition polymerization (including ring-opening polymerization) or condensation polymerization. In other words, it is preferable that the polymerizable groups be functional groups with which an addition polymerization reaction or a condensation polymerization reaction is possible.

A compound that includes a polymerizable group as described above is preferable as the discotic liquid crystal that can be used as the principal raw material of the optically anisotropic layer of the present invention.

[Discotic Liquid Crystal Compound]

Discotic liquid crystal compounds include the benzene derivative described in the research report Mol. Cryst. Volume 71, page 111 (1981) by C. Destrade et al., the truxene derivatives described in the research reports Mol. Cryst. Volume 122, page 141 (1985) and Physics Lett, A, volume 78, page 82 (1990) by C. Destrade et al., the cyclohexane derivative described in the research report Angew. Chem. Volume 96, page 70 (1984) by B. Kohne et al., and the azacrown-based and phenylacetylene-based macrocycles described in the research report J. Chem. Commun., page 1794 (1985) by J. M. Lehn et al. and the research report J. Am. Chem. Soc. Volume 116, page 2655 (1994) by J. Zhang et al.

The discotic liquid crystal compounds also include compounds with liquid crystallinity with a structure in which a straight-chained alkyl group, an alkoxy group, or a substituted benzoyloxy group is radially substituted as a side chain of the mother nucleus with respect to the mother nucleus at the center of the molecule. It is preferable that the molecule or the aggregate of the molecule be a compound with rotational symmetry which can confer a certain orientation.

In a case when an optically anisotropic layer is formed from a discotic liquid crystal compound, the compound that is eventually included in the optically anisotropic layer no longer needs to have liquid crystallinity. For example, in a case when the optically anisotropic layer is formed by a low molecular discotic liquid crystal compound including a group that reacts to heat or light, and by the group reacting with heat or light, polymerizing or cross-linking, and attaining high molecular mass, the compound that is included in the optically anisotropic layer may no longer have liquid crystallinity.

A preferable example of a discotic liquid crystal compound is described in JP1996-50206A (JP-H08-50206A), paragraph number [0052] in JP2006-76992A, and paragraph numbers [0040] to [0063] in JP2007-2220A. For example, the compounds represented by General Formulae DI and DII below are preferable as the compounds having high birefringence. Furthermore, among the compounds represented by General Formulae DI and DII below, a compound with discotic liquid crystallinity is preferable, and in particular, a compound with a discotic nematic phase is preferable. Specific descriptions of the details of the compounds below (definition of the symbols in the formulae, and the preferable ranges thereof) are in the gazettes above.

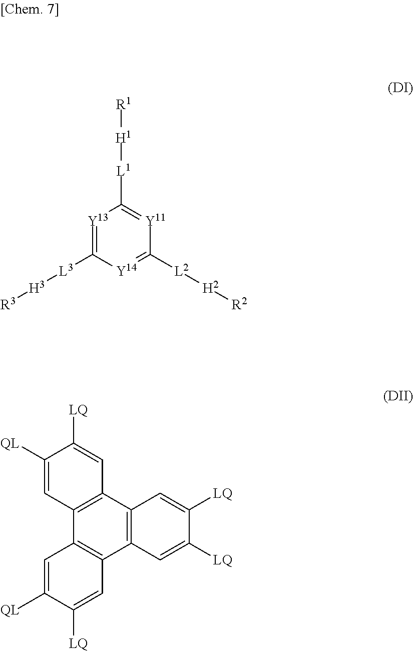

Further, the compound described in JP2005-301206A is also included in the preferable examples of the discotic liquid crystal compound.

[Onium Salt Compound (Oriented Film Side Orientation Control Agent]

In the present invention, as described above, it is preferable that an onium salt be added in order to realize vertical orientation of a liquid crystal compound that includes a polymerizable group, in particular, of a discotic liquid crystal that includes a polymerizable group. The onium salt is unevenly distributed in the oriented face interface, and has the effect of increasing the tilt angle of the liquid crystal molecules in the vicinity of the oriented film interface.

The compound represented by General Formula 1 below is preferable as the onium salt.

Z—(Y-L-)ₙCy⁺·X⁻ General Formula 1

In the formula, Cy is an onium group with a five or six-membered ring, L, Y, Z, and X are the same as L²³, L²⁴, Y²², Y²³, Z²¹, and X in General Formula II described later, the preferable ranges thereof are also the same, and N represents an integer of equal to or greater than 2.

As the five or six-membered ring onium group (cy), a pyrazolium ring, an imidazolium ring, a triazolium ring, a tetrazolium ring, a pyridinium ring, a pyrazinium ring, a pyrimidinium ring, or a triadinium ring is preferable, and an imidazolium ring or a pyrimidinium ring is particularly preferable.

It is preferable that the five or six-membered ring onium group (cy) include a group with affinity with the oriented film material. In the onium salt compound, portions in which the acid generator has not disintegrated (unexposed portions) have high affinity with the oriented film material and are unevenly distributed on the oriented film interface. On the other hand, in portions in which the acid generator has disintegrated and an acidic compound is generated (exposed portions), the anions of the onium salt are ion-exchanged, affinity is lowered, and uneven distribution on the oriented film interface is lowered. It is preferable that affinity using hydrogen bonds be used since with hydrogen bonds, both a bonding state and a state in which the bonds break down are possible within the actual temperature range in which the liquid crystal is oriented (approximately from room temperature to 150° C.). However, the present invention is not limited to such an example.

For example, in an aspect in which polyvinyl alcohol is used as the oriented film material, it is preferable that a group with hydrogen bonds be included in order to form hydrogen bonds with a hydroxyl group. As a theoretical interpretation of hydrogen bonds, there is the report of Journal of American Chemical Society, volume 99, pages 1316 to 1332, 1977 by H. Uneyama and K. Morokuma. An example of a specific form of hydrogen bonds is the form described in FIG. 17 of Intermolecular and Surface Forces, the McGraw-Hill Companies, Inc., 1991, page 98 by J. N. Israelachvili and translated by Yasu Kondo and Hiroyuki Oshima. A specific example of hydrogen bonds is the example described in Angewante Chemistry International Edition English, volume 34, page 2311, 1995 by G. R. Desiraju.

The five or six-membered ring onium group that includes a group with hydrogen bonds promotes not only the effect of the hydrophilicity of the onium group but also, in addition to increasing the surface uneven distribution on the oriented film interface by forming hydrogen bonds with polyvinyl alcohol, confers the function of enabling an orthogonal orientation with respect to the main chain of the polyvinyl alcohol. Examples of preferable groups with hydrogen bonds include an amino group, a carboxylic amide group, a sulfonamide group, an acid amide group, an ureide group, a carbamoyl group, a carboxyl group, a sulfo group, and a nitrogen-containing heterocyclic group (for example, an imidazolyl group, abenzimidazolyl group, a pyrazolyl group, a pyridyl group, a 1,3,5-triazyl group, a pyrimidyl group, a pyridazyl group, a quinolyl group, a benzimidazolyl group, a benzothiazolyl group, a succinic amide group, a phthalimide group, a maleimide group, an uracil group, a thiouracil group, a barbituric acid group, a hydantoin group, a maleic hydrazide group, an isatin group, an uramil group, and the like can be exemplified). Furthermore, examples of preferable groups with hydrogen bonds include an amino group and a pyridyl group.

For example, it is also preferable that a group with an atom capable of forming hydrogen bonds be contained in the five or six-membered ring onium ring as with a nitrogen atom in an imidazolium ring.

As n, an integer from 2 to 5 is preferable, 3 or 4 is more preferable, and 3 is particularly preferable. A plurality of L's and Y's may be the same as, or different from, one another. In a case when n is equal to or greater than 3, since the onium salt represented by General Formula 1 includes three or more five or six-membered rings and there is strong inter-molecular π-π interaction with the discotic liquid crystal, vertical orientation of the discotic liquid crystal can be realized, and in particular, on the polyvinyl alcohol oriented film, orthogonal vertical orientation with respect to the main chain of the polyvinyl alcohol can be realized.

It is particularly preferable that the onium salt represented by General Formula 1 described above be the pyridinium compound represented by General Formula 2a below or the imidazolium compound represented by General Formula 2b below.

The compounds represented by General Formulae 2a and 2b are added mainly for the purpose of controlling the orientations of the discotic liquid crystal represented by General Formulae Ito IV described above on the oriented film interface, and have the effect of increasing the tilt angle of the discotic liquid crystal molecules in the vicinity of the oriented film interface.

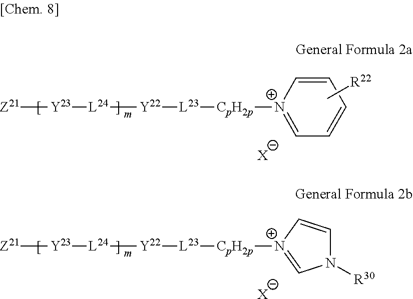

In the formula, L²³ and L²⁴ respectively represent a divalent linked group.

It is preferable that L²³ have a single bond, be —O—, —O—CO—, —C≡—, —CH═CH—, —CH═N—, —N═CH—, —N═N—, —O-L-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, or —O—CO-AL-CO—O—O—, and AL is an alkylene group with 1 to 10 carbon atoms. It is preferable that L²³ be a single bond, be —O—, —O-AL-O—, —O-AL-O—CO—, —O-AL-CO—O—, —CO—O-AL-O—, —CO—O-AL-O—CO—, —CO—O-AL—CO—O—, —O—CO-AL-O—, —O—CO-AL-O—CO—, or —O—CO-AL-CO—O, a single bond or —O— is more preferable, and —O— is most preferable.

L²⁴ preferably is a single bond or is —O—, —O—CO—, —CO—O—, —C≡C—, —CH═CH—, —CH═N—, —N═CH—, or —N═N—, and is more preferably —O—CO— or —CO—O—. It is even more preferable that when m is equal to or greater than 2, a plurality of L²⁴s be alternately —O—CO— and —CO—O—.

R²² is a hydrogen atom, an unsubstituted amino group, or an amino group that is substituted with an alkyl group with 1 to 20 carbon atoms.

In a case when R²² is a dialkyl-substituted amino group, a nitrogen-containing heterocyclic ring may be formed by two alkyl groups being linked with each other. The nitrogen-containing heterocyclic ring that is formed then is preferably a five-membered ring or a six-membered ring. It is even more preferable that R²² be a hydrogen atom, an unsubstituted amino group, or a dialkyl-substituted amino group with 2 to 12 carbon atoms, and it is further preferable that R²² be a hydrogen atom, an unsubstituted amino group, or a dialkyl-substituted amino group with 2 to 8 carbon atoms. In a case when R²² is an unsubstituted amino group or a substituted amino group, it is preferable that the fourth position of the pyridinium ring be substituted.

X is an anion.

It is preferable that X be a monovalent anion. Examples of the anion include halide ions (fluorine ion, chlorine ion, bromine ion, iodine ion) and sulfonate ions (methane sulfonate ion, p-toluene sulfonate ion, benzene sulfonate ion).

Y²² and Y²³ are respectively a divalent linked group with a five or six-membered ring partial structure.

The five or six-membered ring may include a substituent. At least one of Y²² and Y²³ is preferably a divalent linked group with a five or six-membered ring that includes a substituent as a partial structure. It is preferable that Y²² and Y²³ are each independently a divalent linked group with a six-membered ring that may include a substituent as a partial structure. A six-membered ring includes an aliphatic ring, an aromatic ring (benzene ring), and a heterocyclic ring. Examples of a six-membered aliphatic ring include a cyclohexane ring, a cyclohexene ring, and a cyclohexadiene ring. Examples of the six-membered aromatic ring include a pyran ring, a dioxane ring, a dithiane ring, a thin ring, pyridine ring, a piperidine ring, an oxazine ring, a morpholine ring, thiazine ring a pyridazine ring, a pyrimidine ring, a pyrazine ring, a piperazine ring, and a triazine ring. Other six-membered rings or five-membered rings may be condensed in the six-membered ring.

Examples of the substituent include a halogen atom, a cyano, an alkyl group with 1 to 12 carbon atoms, and an alkoxy group with 1 to 12 carbon atoms. The alkyl group and the alkoxy group may be substituted with an acyl group with 2 to 12 carbon atoms or an acyloxy group with 2 to 12 carbon atoms. It is preferable that the substituent be an alkyl group with 1- to 12 (more preferably 1 to 6, and even more preferably 1 to 3) carbon atoms. There may be two or more substituents, and for example, in a case when Y²² and Y²³ are phenylene groups, the 1 to 4 carbon atoms may be substituted with an alkyl group with 1 to 12 (more preferably 1 to 6, and even more preferably 1 to 3) carbon atoms.

Here, m is 1 or 2, and is preferably 2. When m is 2, the plurality of Y²³s and L²⁴s may be the same or different from one another.

Z²¹ is a monovalent group selected from a group including a halogen-substituted phenyl, a nitro-substituted phenyl, a phenyl that is substituted with an alkyl group with 1 to 10 carbon atoms, a phenyl that is substituted with an alkoxy group with 2 to 10 carbon atoms, an alkyl group with 1 to 12 carbon atoms, an alkynyl group with 2 to 20 carbon atoms, an alkoxy group with 1 to 12 carbon atoms, an alkoxycarbonyl group with 2 to 13 carbon atoms, an aryloxycarbonyl group with 7 to 26 carbon atoms, and an arylcarbonyloxy group with 7 to 26 carbon atoms.

In a case when m is 2, Z²¹ is preferably a cyano, an alkyl group with 1 to 10 carbon atoms, or an alkoxy group with 1 to 10 carbon atoms, and even more preferably an alkoxy group with 4 to 10 carbon atoms.

In a case when m is 1, it is preferable that Z²¹ be an alkyl group with 7 to 12 carbon atoms, an alkoxy group with 7 to 12 carbon atoms, an acyl-substituted alkyl group with 7 to 12 carbon atoms, an acyl-substituted alkoxy group with 7 to 12 carbon atoms, an acyloxy-substituted alkyl group with 7 to 12 carbon atoms, or an acyloxy-substituted alkoxy group with 7 to 12 carbon atoms.

An acyl group is represented by —CO—R, an acyloxy group is represented by —O—CO—R, and R is an aliphatic group (alkyl group, substituted alkyl group, alkenyl group, substituted alkenyl group, alkynyl group, or substituted alkynyl group) or an aromatic group (aryl group, substituted aryl group). R is preferably an aliphatic group and even more preferably an alkyl group or an alkenyl group.

p is an integer between 1 and 10. It is particularly preferable that p be 1 or 2. CₚH₂ₚ signifies a chained alkylene group that may have a branched structure. It is preferable that CₚH₂ₚ be a straight-chain alkylene group (—CH₂)ₚ—).

In Formula 2b, R³⁰ is a hydrogen atom or an alkyl group with 1 to 12 (more preferably 1 to 6, and even more preferably 1 to 3) carbon atoms.

Among the compounds represented by Formulae 2a and 2b, the compounds represented by Formulae 2a′ and 2b′ below are preferable.

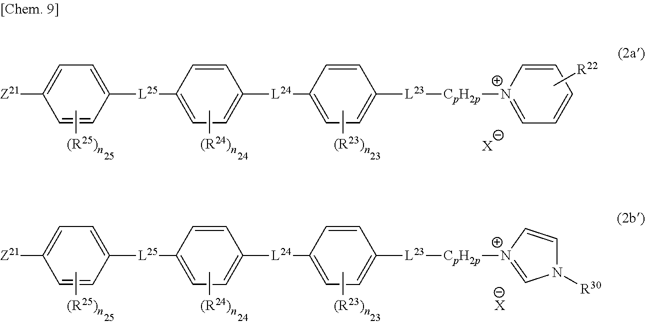

In Formulae 2a′ and 2b′, the symbols that are the same as Formula 2a mean the same, and the preferable ranges are also the same. L²⁵ and L²⁴ have the same meaning, and the preferable ranges are also the same. It is preferable that L²⁴ and L²⁵ be —O—CO— or —CO—O—, and L²⁴ is preferably —O—CO— and L²⁵ is preferably —CO—O—.

R²³, R²⁴, and R²⁵ are respectively alkyl groups with 1 to 12 (more preferably 1 to 6, and even more preferably 1 to 3) carbon atoms. n₂₃ represents 0 to 4, n₂₄ represents 1 to 4, and n₂₅ represents 0 to 4. It is preferable that n₂₃ and n₂₅ be 0 and n₂₄ be 1 to 4 (more preferably 1 to 3).

It is preferable that R³⁰ be an alkyl group with 1 to 12 (more preferably 1 to 6, and even more preferably 1 to 3) carbon atoms.

A specific example of the compound represented by General Formula 1 is the compound described in [0058] to [0061] of JP2006-113500A.

Specific examples of the compound represented by General Formula 1 are shown below. However, in the formulae below, the anions (X⁻) are omitted.

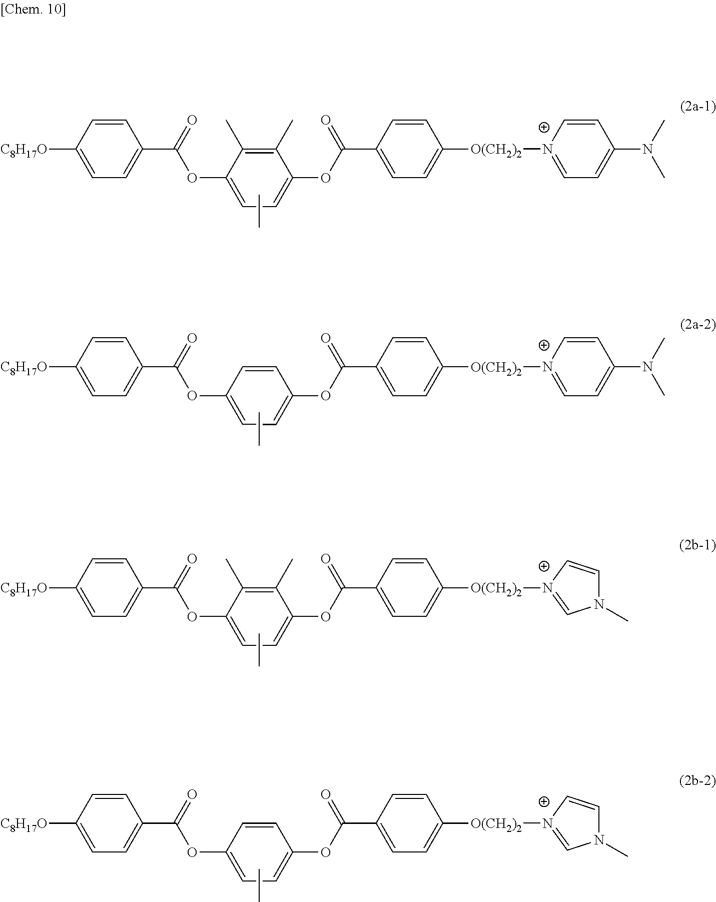

The compounds of Formulae 2a and 2b can be manufactured by a common method. For example, the pyridinium derivative of Formula 2a is commonly obtained by turning the pyridine ring into an alkyl (Menschutkin reaction).

It is preferable that the addition amount of the onium salt do not exceed 5 mass % with respect to the liquid crystal compound and be approximately 0.1 to 2 mass %.

Since the pyridinium group or the imidazolium group is hydrophilic, the onium salts represented by General Formulae 2a and 2b are unevenly distributed on the hydrophilic polyvinyl alcohol oriented film surface. In particular, if an amino group (amino group in which R²² is substituted with an unsubstituted amino group or an alkyl group with 1 to 20 carbon atoms in General Formulae 2a and 2a′) that is a substituent of the acceptor of a hydrogen atom is further substituted in the pyridinium group, an intermolecular hydrogen bond is created between the substituted group and the polyvinyl alcohol and the compound is unevenly distributed on the oriented film surface with high density, and due to the effect of the hydrogen bonds, since a pyridinium derivative is oriented in a direction that is orthogonal to the main chain of the polyvinyl alcohol, the orthogonal orientation of the liquid crystal with respect to the rubbing direction is promoted. Since the pyridinium derivative has a plurality of aromatic rings in the molecule, a strong intermolecular π-π interaction is caused between the liquid crystal molecules, in particular the discotic liquid crystal molecules described above, and the orthogonal orientation of the discotic liquid crystal in the vicinity of the oriented film interface is induced. In particular, as illustrated in General Formula 2a′, if a hydrophobic aromatic group is coupled with the hydrophilic pyridinium group, there is also an effect of inducing vertical orientation through the hydrophilic effect.

Furthermore, if the onium salts represented by General Formulae 2a and 2b are used together, anion exchange takes place with the acidic compound that is released from the photoacid generator through photolysis, and the uneven distribution on the oriented film interface is lowered by the hydrogen bond force and the hydrophilicity of the onium salts changing, promoting horizontal orientation in which the slow axis of the liquid crystal is oriented horizontally with respect to the rubbing direction. This is because the onium salts are evenly dispersed on the oriented film through salt exchange and the density on the oriented film surface decreasing, and the liquid crystal being oriented by the regulating force of the rubbing oriented film itself.

[Fluoroaliphatic Group-Containing Copolymer (Air Interface Orientation Control Agent)]

A fluoroaliphatic group-containing copolymer is added for the purpose of controlling the orientation of the liquid crystal in the air interface, and has an effect of increasing the tilt angle of the liquid crystal molecules in the vicinity of the air interface. Furthermore, applicability in terms of unevenness, cissing, and the like is also improved.

A fluoroaliphatic group-containing copolymer that can be used in the present invention can be selected from the compounds described in the gazettes and specifications of JP2004-333852A, JP2004-333861A, JP2005-134884A, JP2005-179636A, and JP2005-181977A, and the like. Particularly preferable is a polymer that includes, as a side chain, the fluoroaliphatic group described in JP2005-179636A and JP2005-181977A and one or more hydrophilic groups that are selected from a group including a carboxyl group (—COOH), a sulfo group (—SO₃H), phosphonooxy {—OP(═O)(OH)₂}, and salts thereof.

It is preferable that the addition amount of the fluoroaliphatic group-containing copolymer do not exceed 2 mass % with respect to the liquid crystal compound and be approximately 0.1 to 1 mass %.

The fluoroaliphatic group-containing copolymer can increase the uneven distribution on the air interface through the hydrophobic effect of the fluoroaliphatic group, can provide space for low surface energy on the air interface side, and can increase the tilt angle of the liquid crystal, in particularly, of the discotic liquid crystal. Furthermore, by including a copolymer component that includes one or more hydrophilic groups that are selected from a group including a carboxyl group (—COOH), a sulfo group (—SO₃H), phosphonooxy {—OP(═O)(OH)₂}, and salts thereof in the side chain, vertical orientation of the liquid crystal compound can be realized through charge repulsion between the anions and the π electrons of the liquid crystal.

[Solvent]

It is preferable that the composition that is used in the formation of the optically anisotropic layer be prepared as a coating liquid. An organic solvent is preferably used as the solvent that is used in the preparation of the coating liquid. Examples of organic solvent include amides (for example, N,N-dimethylformamide), sulfoxides (for example, dimethyl sulfoxide), heterocyclic compounds (for example, pyridine), hydrocarbons (for example, benzene, hexane), alkyl halides (for example, chloroform, dichloromethane), esters (for example, methyl acetate, butyl acetate), ketones (for example, acetone, methyl ethyl ketone), ethers (for example, tetrahydrofuran, 1,2-dimethoxyethane). Alkyl halides and ketones are preferable. Two or more types of organic solvents may be used together.

[Polymerization Initiator]

After the composition (for example, the coating liquid) that contains the liquid crystal compound that includes the polymerizable group is made to be in an orientation state with the desired liquid crystal phase, the polymerization reaction is advanced and the orientation is fixed (step 5 in the method described above. It is preferable that the fixing is carried out through the polymerization reaction of a reactive group that is introduced to the liquid crystal compound. Fixing through a photopolymerization reaction using ultraviolet irradiation is preferable. The photopolymerization reaction may be either radical polymerization or cationic polymerization. Examples of radical photopolymerization initiators include an α-carbonyl compound (described in U.S. Pat. No. 2,367,661A and U.S. Pat. No. 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. No. 3,046,127A and U.S. Pat. No. 2,951,758A), a combination of a triaryl imidazole dimer and a p-amino phenyl ketone (described in U.S. Pat. No. 3,549,367A), an acridine and phenazine compound (described in JP1985-105667A (JP-S60-105667A) and U.S. Pat. No. 4,239,850A), and an oxadiazole compound (described in U.S. Pat. No. 4,212,970A). Examples of cationic photopolymerization initiators include organic sulfonium salts, iodonium salts, phosphonium salts, and the like, wherein an organic sulfonium salt is preferable, and a triphenyl sulfonium salt is particularly preferable. Hexafluoroantimonate, hexafluorophosphate, or the like is preferably used as counterions in such compounds.

The usage amount of the photopolymerization initiator is preferably 0.01 to 20 mass % of the solid content of the coating liquid, and 0.5 to 5 mass % is even more preferable.

[Sensitizer]

Further, in order to increase sensitivity, a sensitizer may be used in addition to a polymerization initiator. Examples of sensitizers include n-butylamine, triethylamine, tri-n-butylphosphine, thioxanthone, and the like. A plurality of types of photopolymerization initiators may be combined, and the usage amount is preferably 0.01 to 20 mass % of the solid content of the coating liquid and more preferably 0.5 to 5 mass %. It is preferable that ultraviolet rays be used for the light irradiation for the polymerization of the liquid crystal compound.

[Other Additives]

The composition described above may contain a non-liquid crystalline polymerizable monomer separately from the polymerizable liquid crystal compound. A compound that includes a vinyl group, a vinyloxy group, an acryloyl group, or a methacryloyl group is preferable as the polymerizable monomer. Here, it is preferable that a multi-functional monomer with two or more polymerizable reaction functional groups, for example, an ethylene oxide-modified trimethylolpropane acrylate, be used so that durability is improved. Since the non-liquid crystalline polymerizable monomer has non-liquid crystalline components, it is preferable that the addition amount thereof do not exceed 40 mass % with respect to the liquid crystal compound and be approximately 0 to 20 mass %.

In such a manner, although the thickness of the optically anisotropic layer that is formed is not particularly limited, 0.1 to 10 μm is preferable and 0.5 to 5 μm is more preferable.

[Polarizing Film]

The optical film of the present invention preferably includes a polarizing film. In the polarizing film, it is preferable that the surface of the optically anisotropic layer film (transport support side surface) and the surface of the polarizing film be bonded together, and it is preferable that the bonding be carried out so that the intersecting angle between the rubbing direction of the oriented film of the phase difference film of the present invention and the transmission axis of the polarizing film be substantially 90 degrees. There is no need for the angle to be strictly 0 degrees, and an error of approximately ±5 degrees which is tolerated in manufacturing does not influence the effect of the present invention and is tolerated. Further, as described above, it is preferable that a polarizing film protective film such as a cellulose acylate film be bonded onto the other face of the polarizing film.

With polarizing films, there are iodine-based polarizing films, dye-based polarizing films that use dichroic dyes, and polyene-based polarizing films, any of which may be used in the present invention. Iodine-based polarizing films and dye-based polarizing films are generally manufactured using a polyvinyl alcohol-based film. For manufacturing methods of polarizing films, the description of, for example, JP2011-128584A can be considered.

<Polarizing Film Protective Film>

A transparent polymer film is preferable as the protective film that is bonded onto the surface of the polarizing film. To be transparent is to have light transmission of equal to or greater than 80%. A cellulose acylate film, or a polyolefin film or acrylic film that includes a polyolefin is preferable as the protective film. Among cellulose acylate films, a cellulose triacetate film is preferable. Further, among polyolefin films, a polynorbornene film that includes a cyclic polyolefin is preferable. The thickness of the protective film is preferably 20 to 500 μm and even more preferably 40 to 100 μm.

<Transparent Support>

The optical film of the present invention includes a transparent support. It is preferable that a member with hardly any phase difference in the in-plane and thickness directions be used as the transparent support.

A polymer that is excellent in optical transparency, mechanical strength, thermal stability, moisture shielding properties, isotropy, and the like is preferable as the material that forms the transparent support that can be used in the present invention, and any material within a range in which Re and Rth described above satisfy Formula I described above may be used. For example, there are polycarbonate-based polymers, polyester-based polymers such as polyethylene terephthalate and polyethylene naphthalate, acryl-based polymers such as polymethylmethacrylate, and styrene-based polymers such as polystyrene and an acrylonitrile-styrene copolymer (AS resin). Further, examples also include polyolefins such as polyethylene and polypropylene, polyolefin-based polymers such as an ethylene-propylene copolymer, vinyl chloride-based polymers, amide-based polyolefin polymers such as nylon and an aromatic polyamide, imide-based polymers, sulfone-based polymers, polyether sulfone-based polymers, polyether ether ketone-based polymers, polyphenylene sulfide-based polymers, vinylidene chloride polymers, vinyl alcohol-based polymers, vinyl polymer butyral-based polymers, arylate-based polymers, polyoxymethylene-based polymers, epoxy-based polymers, and polymers in which the polymers described above are mixed. Further, the polymer film of the present invention may also be formed as a cured layer of an acryl-based, urethane-based, acrylic urethane-based, epoxy-based, or silicon-based ultraviolet curing or thermosetting resin, or the like.

Further, a thermoplastic norbornene-based resin is used preferably as the material that forms the transparent support. Examples of thermoplastic norbornene-based resins include ZEONEX and ZEONOR manufactured by Zeon Corporation and ARTON manufactured by JSR Corporation, and the like.

Further, a cellulose-based polymer (hereinafter referred to as cellulose acylate) typified by triacetyl cellulose which has been used as a transparent protective film for polarizing plates in the related art is preferably used as the material that forms the transparent support.

While details of cellulose acylate will be mainly described below as an example of the transport support, it is obvious that the technical matters thereof can be similarly applied to other polymer films.

Cotton linter, wood pulp (deciduous pulp, coniferous pulp), and the like are used as the cellulose of the raw material of the cellulose acylate, and a cellulose acylate obtained from any raw material can be used, and may be at times used mixed. While details of such raw material celluloses are described, for example, in Plastic Materials Course (17) Cellulose-Based Resins (authored by Marusawa and Uda, Nikkan Kogyo Shimbun, Ltd., published 1970) and the Japan Institute of Invention and Innovation Public Technical Report 2001-1745 (pages 7 to 8), the present invention is not limited to the description.

Cellulose acylate has the hydroxyl group of the cellulose turned into acyl, and any material from an acetyl group with 2 carbon atoms to an acyl group to 22 carbon atoms may be used as a substituent thereof. While the degree of substitution of the hydroxyl groups of the cellulose is not particularly limited in the cellulose acylate of the present invention, the degree of substitution can be obtained through calculation by measuring one or both of the acetate that is substituted in the hydroxyl group of the cellulose and the degree of linking in a fatty acid of 3 to 22 carbon atoms. The measurement Method can be executed in accordance with D-817-91 of ASTM.

While the degree of substitution to the hydroxyl group of the cellulose is not particularly limited, it is desirable that the degree of acyl substitution of the hydroxyl groups of the cellulose be 2.50 to 3.00. Further, the degree of substitution is desirably 2.75 to 3.00 and more desirably 2.85 to 3.00.

Among one or both of the acetate that is substituted in the hydroxyl groups of the cellulose and the fatty acids of 3 to 22 carbon atoms, the acyl group of 2 to 22 carbon atoms may be an aliphatic group or an aromatic group and is not particularly limited, and may be singular or a mixture of two or more types. The materials are, for example, an alkylcarbonyl ester, an alkenyl carbonyl ester, an aromatic carbonyl ester, an aromatic alkyl carbonyl ester, or the like of the cellulose, each of which may include a group that is further substituted. Preferable examples of the acyl groups include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexane carbonyl, oleoyl, benzoyl, naphthyl carbonyl, a cinnamoyl group, and the like. Among the materials, acetyl, propionyl, butanoyl, dodecanoyl, octadecanoyl, t-butanoyl, oleoyl, benzoyl, naphthyl carbonyl, cinnamoyl, and the like are preferable, and acetyl, propionyl, and butanoyl are more preferable.

In a case when a material is effectively including at least two types of an acetyl group, a propionyl group, and a butanoyl group among the acyl substituents that substitute the hydroxyl group of the cellulose described above, the optical anisotropy of the cellulose acylate film can be decreased in a case when the degree of substitution is 2.50 to 3.00. The degree of acyl substitution is more preferably 2.60 to 3.00 and further desirably 2.65 to 3.00. Further, in a case when the acyl substituent that substitutes the hydroxyl group of the cellulose is including only an acetyl group, in addition to the optical anisotropy of the film decreasing, from the viewpoints of compatibility with the additives and solubility in the organic solvent that is used, the degree of substitution is preferably 2.80 to 2.99 and more preferably 2.85 to 2.95.

The degree of polymerization of the cellulose acylate is preferably a viscosity average degree of polymerization of 180 to 700, and in the cellulose acylate, 180 to 550 is preferable, 180 to 400 is more preferable, and 180 to 350 is particularly preferable. If the degree of polymerization is too high, the viscosity of the doping solution of the cellulose acylate increases, making the creation of the film difficult due to casting. If the degree of polymerization is too low, the strength of the created film decreases. The average degree of polymerization can be measured using a limiting viscosity method of Uda et al. (Kazuo Uda, Hideo Saito, Fiber Journal, volume 18, number 1, pages 105 to 120, 1962). Details are described in JP1997-95538A (JP-H09-95538A).

Further, the molecular weight distribution of the cellulose acylate that is preferably used in the present invention is evaluated using gel permeation chromatography, and it is preferable that a polydispersity index Mw/Mn (Mw is the weight average molecular weight, Mn is the numerical average molecular weight) thereof be small and the molecular weight distribution be narrow. As a specific value of Mw/Mn, 1.0 to 3.0 is preferable, 1.0 to 2.0 is even more preferable, and 1.0 to 1.6 is most preferable.

When low-molecular-weight components are removed, the average molecular weight (degree of polymerization) rises, which is useful since the viscosity becomes lower than with the ordinary cellulose acylate. Cellulose acylate with few low-molecular-weight components can be obtained by removing low-molecular-weight components from a cellulose acylate that is synthesized through an ordinary method. The removal of low-molecular-weight components can be performed by washing the cellulose acylate with an appropriate organic solvent. Here, in a case when a cellulose acylate with few low-molecular-weight components is manufactured, it is preferable that the sulfuric acid catalyst amount in the acetylation reaction be adjusted to be 0.5 to 25 parts by mass with respect to 100 parts by mass of the cellulose. If the amount of the sulfuric acid solvent is within the range described above, a cellulose acylate that is also favorable in terms of the molecular weight distribution (with even molecular weight distribution) can be synthesized. When being used in the manufacture of the cellulose acylate of the present invention, the moisture content is preferably equal to or less than 2 mass %, even more preferably equal to or less than 1 mass %, and particularly preferably equal to or less than 0.7 mass %. Cellulose acylates generally contain water, and are known to have a moisture content of 2.5 to 5 mass %. Drying is necessary to achieve the cellulose acylate moisture content, and the method of doing so is not particularly limited as long as the target moisture content is achieved. The cellulose acylate synthesis methods of the present invention are described in detail in pages 7 to 12 of the Japan Institute of Invention and Innovation Public Technical Report (Public Report Number 2001-1745, published Mar. 15, 2001, Japan Institute of Invention and Innovation).

With the cellulose acylate, as long as the substituent, the degree of substitution, the degree of polymerization, the molecular weight distribution, and the like are within the ranges described above, a single or a mixture of two or more types of different cellulose acylates may be used.

In the creation of the film that is used as a support, various additives (for example, compounds that lower the optical anisotropy, wavelength dispersion adjusting agents, fine particles, plasticizers, ultraviolet inhibitors, anti-deterioration agents, peeling agents, optical property adjusting agents, and the like) can be used in addition to the cellulose acylate, which are described below. Further, while the time period during which the additives are added may be at any time during the dope creation process (the creation process of the cellulose acylate solution), a process of adding the additives and preparing may be performed at the end of the dope creation process.

By adjusting the addition amounts of the additives, a cellulose acylate film that satisfies 0 nm≦Re (550)≦10 nm can be created, and by using the film as a support, all Re's of the first and second phase difference regions which are included in the optical film of the present invention can be within the range 110 nm≦Re (550)≦165 nm while hardly being influenced by the optical characteristics of the support. The Re value is preferably 120 nm≦Re (550)≦145 nm and particularly preferably 130 nm≦Re (550)≦145 nm.

Further, in the relationship with the optically anisotropic layer described later, since the sum of the Rth of the transparent support and the Rth of the optically anisotropic layer (λ/4 plate) satisfies |Rth|≦20 nm, it is preferable that the transparent support satisfies −150 nm≦Rth (630)≦100 nm.

A desirable aspect is also to contain at least one type of compound that lowers the optical anisotropy of the cellulose acylate film.

Compounds that lower the optical anisotropy of the cellulose acylate film will be described. The optical anisotropy can be lowered by using a compound that suppresses the cellulose acylate within the film from being oriented within the plane or in the film thickness direction. A compound that lowers the optical anisotropy is sufficiently compatible with the cellulose acylate and which itself does not have a rod-like structure or a flat structure is favorable. Specifically, in a case when there are a plurality of flat functional groups as with an aromatic group, a structure in which the functional groups are not on the same flat face but are on non-flat faces is favorable.

In order to create a cellulose acylate film with a low phase difference, of the compounds that lower the optical anisotropy by suppressing the cellulose acylate in the film from being oriented within the plane and in the film thickness direction as described above, a compound in which the octanol-aqueous distribution coefficient (log P value) is 0 to 7 is preferable. A compound in which the log P value exceeds 7 has poor compatibility with the cellulose acylate, and clouding and powdering of the film tends to occur. Further, since a compound with a log P value of less than 0 has strong hydrophilicity, there may be a case when the water resistance of the cellulose acylate film deteriorates. An even more preferable range of the log P value is 1 to 6, and a particularly preferable range is 1.5 to 5.

Measurement of the octanol-aqueous distribution coefficient (log P value) can be performed by the flask immersion method described in JIS Japan Industrial Standard Z7260-107 (2000). Further, instead of actual measurement, the octanol-aqueous distribution coefficient (log P value) can also be estimated by a computation chemical technique or an empirical method. While Crippen's fragmentation method (J. Chem. Inf. Comput. Sci., 27, 21 (1987)), Viswanadhan's fragmentation method (J. Chem. Inf. Comput. Sci., 29, 163 (1989)), Broto's fragmentation method (Eur. J. Med. Chem.-Chim. Theor., 19, 71 (1984)), and the like are used as preferable calculation methods, Crippen's fragmentation method (J. Chem. Inf. Comput. Sci., 27, 21 (1987)) is more preferable. In a case when the log P value of a given compound differs according to the measurement method or the calculation method, whether or not the compound in within the range is preferably determined by Crippen's fragmentation method. Here, the log P value described in the present specification was found by Crippen's fragmentation method (J. Chem. Inf. Comput. Sci., 27, 21 (1987)).

A compound that lowers the optical anisotropy may or may not contain an aromatic group. Further, a compound that lowers the optical anisotropy preferably has a molecular weight of equal to or greater than 150 and equal to or less than 3000, more preferably equal to or greater than 170 and equal to or less than 2000, and particularly preferably equal to or greater than 200 and equal to or less than 1000. As long as the molecular weight is within such ranges, the compound may have a specific monomer structure, an oligomer structure in which a plurality of such monomer units are linked, or a polymer structure.

A compound that lowers the optical anisotropy is preferably a liquid at 25° C. or is a solid with a melting point of 25° C. to 250° C., and is even more preferably a liquid at 25° C. or a solid with a melting point of 25° C. to 200° C. Further, it is preferable that a compound that lowers the optical anisotropy not be vaporized over the course of the dope casting and drying processes during the production of the cellulose acylate film.

There is preferably 0.01 to 30 mass % of a compound that lowers the optical anisotropy with respect to the cellulose acylate, more preferably 1 to 25 mass %, and particularly preferably 5 to 20 mass %.

A compound that lowers the optical anisotropy may be used alone or two or more compounds may be used mixed with desired ratios.

The time period during which a compound that lowers the optical anisotropy is added may be at a time during the dope creation process, and the addition may be performed at the end of the dope creation process.

The average content of a compound that lowers the optical anisotropy at a portion from at least the surface of one side to 10% of the entire film thickness is 80 to 99% of the average content of the compounds at the center portion of the cellulose acylate film. The amount of the compound can be found by measuring the compound amounts at the surface and the center portion through the method using an infrared absorption spectrum described in JP1996-57879A (JP-H08-57879A), for example.

While the compounds described in [0035] to [0058] of JP2006-199855A are specific examples of compounds that lower the optical anisotropy of the cellulose acylate film, the present invention is not limited to such compounds.

Since the optical film of the present invention is arranged on the viewing side, the optical film tends to be influenced by external light, in particular, ultraviolet rays. It is therefore desirable that an ultraviolet (UV) absorber be added to the polymer film and the like that are used as the transparent support.

As a UV absorber, a compound with absorption for an ultraviolet region of 200 to 400 nm which lowers both the |Re (400)−Re (700)| and the |Rth (400)−Rth (700)| is preferable, and may be present at 0.01 to 30 mass % with respect to the solid content of the cellulose acylate.

Further, in recent years, with liquid crystal devices such as televisions, notebook computers, and mobile phone terminals, excellent transmittance is demanded of the optical member that is used in the liquid crystal display device in order to increase brightness with less power. In that regard, in a case when adding a compound with absorption for an ultraviolet region of 200 to 400 nm which lowers both the |Re (400)−Re (700)| and the |Rth (400)−Rth (700)| to the cellulose acylate film, it is necessary for the spectral transmittance to be excellent. In the cellulose acylate film of the present invention, it is desirable that the spectral transmittance at a wavelength of 380 nm be equal to or greater than 45% and equal to or less than 95% and the spectral transmittance at a wavelength of 350 nm be equal to or less than 10%.

It is preferable that the molecular weight of the UV absorber be 250 to 1000 from the viewpoint of volatility. The molecular weight is more preferably 260 to 800, even more preferably 270 to 800, and particularly preferably 300 to 800. As long as the molecular weight is within such ranges, the compound may have a specific monomer structure, an oligomer structure in which a plurality of such monomer units are linked, or a polymer structure.

It is preferable that the UV absorber not be vaporized over the course of the dope casting and drying processes during the production of the cellulose acylate film.

The compound described in [0059] to [0135] of JP2006-199855A is a specific example of a UV absorber of the cellulose acylate film.

It is preferable that fine particles be added to the cellulose acylate film as a matting agent. Examples of the fine particles that are used in the present invention include silicon dioxide, titanium dioxide, aluminum oxide, zirconium oxide, calcium carbonate, calcium carbonate, talc, clay, calcined kaolin, calcined calcium silicate, hydrated calcium silicate, aluminum silicate, magnesium silicate, and calcium phosphate. Fine particles that include silicon are preferable from the viewpoint of lower turbidity, and silicon dioxide is particularly preferable. It is preferable that the silicon dioxide fine particles have a primary average particle diameter of equal to or less than 20 nm with an apparent specific gravity of equal to or greater than 70 g/liter. A small average diameter of 5 to 16 nm of the primary particles is more preferable to lower the haze of the film. The apparent specific gravity is preferably 90 to 200 g/liter and even more preferably equal to or greater than 100 to 200 g/liter. A greater apparent specific gravity is preferable as a higher concentration dispersion liquid can be made, improving haze and aggregates.

The fine particles usually form secondary particles with an average particle diameter of 0.1 to 3.0 μm, and the fine particles exist in the film as aggregates of the primary particles, forming convexities and concavities of 0.1 to 3.0 μm on the film surface. The secondary average particle size is preferably equal to or greater than 0.2 μm and equal to or less than 1.5 μm, even more preferably equal to or greater than 0.4 μm, equal to or less than 1.2 μm, and most preferably equal to or greater than 0.6 μm and equal to or less than 1.1 μm. The primary and secondary particle diameters were found by observing the particles within the film using a scan type electron microscope and taking the diameters of circles that circumscribe the particles. Further, 200 particles were observed from different locations, and the average value was taken as the average particle diameter.

Commercially available products such as, for example, AEROSIL R972, R972V, R974, R812, 200, 200V, 300, 8202, OX50, and TT600 (all manufactured by Japan Aerosil Co., Ltd.) may be used as the silicon dioxide particles. As zirconium oxide fine particles, for example, commercially available products with the product names Aerosil R976 and 8811 (both manufactured by Japan Aerosil Co., Ltd.) can be used.

Among such products, Aerosil 200V and Aerosil R972V are particularly preferable as silicon dioxide fine particles since the primary average particle diameter is equal to or less than 20 nm, the apparent specific gravity is equal to or greater than 70 g/liter, and there is a strong effect of lowering the friction coefficient while keeping the turbidity of the optical film low.

In the present invention, several techniques can be considered when preparing a dispersion liquid of fine particles in order to obtain a cellulose acylate film that includes fine particles with a small secondary average particle diameter. For example, there is a method of preparing a fine particle dispersion liquid in which a solvent and fine particles are stirred and mixed in advance, adding the fine particle dispersion liquid in a small amount of cellulose acylate solution that is prepared separately and stirring and dissolving, and further mixing with the main cellulose acylate solution (doping liquid). Such a method is a preferable preparation method since the dispersibility of the silicon dioxide particles is good and the silicon dioxide particles tend not to re-agglomerate. Otherwise, there is also a method of adding a small amount of cellulose ester to a solvent and stirring and mixing, adding the fine particles thereto and performing dispersion using a disperser to create a fine particle adding liquid, and sufficiently mixing the fine particle adding liquid with the doping liquid using an inline mixer. While the present invention is not limited to such methods, the concentration of the silicon dioxide when the silicon dioxide fine particles are mixed with a solvent and the like and dispersed is preferably 5 to 30 mass %, even more preferably 10 to 25 mass %, and most preferably 15 to 20 mass %. A higher dispersion concentration is preferable as the liquid turbidity with respect to the addition amount decreases, improving haze and aggregates. The final addition amount of the matting agent fine particles in the cellulose acylate doping solution is preferably 0.01 to 1.0 g/l m³, even more preferably 0.03 to 0.3 g, and most preferably 0.08 to 0.16 g.

Examples of the solvent that is used as lower alcohols preferably include methyl alcohol, ethyl alcohol, propyl alcohol, isopropyl alcohol, butyl alcohol, and the like. While solvents other than lower alcohols are not particularly limited, it is preferable that a solvent that is used when the cellulose ester film is formed be used.

Other than a compound that optically lowers the anisotropy and a UV absorber, various additives (for example, plasticizers, ultraviolet inhibitors, anti-deterioration agents, peeling agents, infrared absorbers, and the like) may be added to the cellulose acylate film according to use, which may be solids or oily matter. That is, the melting points and boiling points thereof are not particularly limited. For example, ultraviolet absorbing materials of equal to or less than 20° C. and equal to or greater than 20° C. are mixed, plasticizers are similarly mixed, or the like, which is described in JP2001-151901A, for example. Furthermore, infrared absorbers are described in JP2001-194522A, for example. While the time period of the addition may be at any point during the dope creation process, the additives may be added at the end of the dope creating process. Furthermore, the addition amount of each additive is not particularly limited as long as the functions thereof are exhibited. Further, in a case when the cellulose acylate film is formed of multiple layers, the types and addition amount of each of the layers may differ. While such techniques are described in JP2001-151902A or the like, for example, the techniques are known in the related art. The materials described in detail in pages 16 to 22 of the Japan Institute of Invention and Innovation Public Technical Report (Public Report Number 2001-1745, published Mar. 15, 2001, Japan Institute of Invention and Innovation) are preferably used.

Further, with regard to plasticizers, although a plasticizer is not added in some of the embodiments described later, needless to say, there is no need to add a plasticizer in the case of a compound in which a compound that optically lowers the anisotropy or the like has the effect of a plasticizer.

It is preferable that the cellulose acylate film be manufactured using a solution film forming method that uses a cellulose acylate solution. The dissolution method in the preparation of the cellulose acylate solution (dope) is not particularly limited, may be performed at room temperature, and is performed using a cooling dissolution method, a high temperature dissolution method, or a combination thereof. The manufacturing process described in detail in pages 22 to 25 of the Japan Institute of Invention and Innovation Public Technical Report (Public Report Number 2001-1745, published Mar. 15, 2001, Japan Institute of Invention and Innovation) is preferably used in each of the processes of solution concentration and filtration that accompany the dissolution process.

The dope transparency of the cellulose acylate solution is desirably equal to or greater than 85%. The dope transparency is more preferably equal to or greater than 88% and even more preferably equal to or greater than 90%. In the present invention, it has been verifies that various additives have been sufficiently dissolved in the cellulose acylate doping solution. As a specific calculation method of the dope transparency, the doping liquid was injected into a glass cell of 1 cm³ and the absorbance at 550 nm was measured using a spectrophotometer (UV-3150, Shimadzu Corporation). The solvent alone was measured as a blank in advance, and the transparency of the cellulose solution was calculated from the ratio with the blank absorbance.

As the method and facility of manufacturing the cellulose acylate film, the solution casting film forming method and the solution casting film forming device that are used in the manufacture of cellulose triacetate films in the related art are used. The dope (cellulose acylate solution) that is prepared from a dissolving machine (pot) is temporarily stored in a storage pot, and final preparation is performed by defoaming the bubbles that are included in the dope. The dope is transferred from a dope discharge opening to a pressurizing die through, for example, a pressurizing metering gear pump that can transfer a fixed amount of liquid with precision according to the number of rotations, the dope is evenly cast onto a metal support of a casting portion that runs continuously from a mouthpiece (slit) of the pressurizing die, and a half-dried dope film (also referred to as a web) is peeled from the metal support at a peeling point that is approximately one revolution of the metal support. Both ends of the obtained web are pinched by clips, the web is transported using a tenter while maintaining the width and dried, and the film that is obtained is mechanically transported by a roller group of the drying machine to end drying, and a predetermined length is wound off in a roll form using a winding machine. The combination of the tenter and the drying machine of the roller group changes according to the objective. In the solution casting film forming method that is used in the functionality protective film that is an optical member for electronic display which is the main use of the cellulose acylate film of the present invention, other than the solution casting film formation device, a coating device is often added for surface processing on the film such as an undercoat layer, an antistatic layer, an antihalation layer, and a protective film. Details of such processing are described in pages 25 to 30 of the Japan Institute of Invention and Innovation Public Technical Report (Public Report Number 2001-1745, published Mar. 15, 2001, Japan Institute of Invention and Innovation), the processing is categorized into casting (including join casting), metal supports, drying, peeling, and the like, which are used favorably in the present invention. Further, the thickness of the cellulose acylate film is preferably 10 to 120 μm, more preferably 20 to 100 μm and even more preferably 30 to 90 μm.

An example of a polymer film that is used as the transparent support is a low phase difference film with an Re of 0 to 10 nm and an absolute value of Rth of equal to or less than 20 nm.

[Coefficient of Moisture Expansion]

While the coefficient of moisture expansion of the polymer film can be appropriately set by the combination with the thermal expansion coefficient, 3.0×10⁻⁶ to 500×10⁻⁶/% RH is preferable, 4.0×10⁻⁶ to 100×10⁻⁶/% RH is more preferable, 5.0×10⁻⁶ to 50×10⁻⁶% RH is even more preferable, and 5.0×10⁻⁶ to 40×10⁻⁶% RH is most preferable.

Here, the thermal expansion coefficient can be measured in accordance with ISO11359-2, and can be calculated, once a sample rises in temperature from room temperature to 80° C., from the gradient of the length of the film when the temperature of the sample falls from 60° C. to 50° C.

Further, when the coefficient of moisture expansion is measured, a film sample with a length of 25 cm (measurement direction) and a width of 5 cm which is cut out so that the direction in which the modulus of elasticity is greatest in the longitudinal direction is prepared, pin holes are made in the sample with an interval of 20 cm, and after conditioning the humidity of the sample for 24 hours at 25° C. and a relative humidity of 10%, the interval between the pin holes is measured using a pin gauge (the measurement value is L₀). Next, after conditioning the humidity of the sample for 24 hours at 25° C. and a relative humidity of 80%, the interval between the pin holes is measured using a pin gauge (the measurement value is L₁). The coefficient of moisture expansion is calculated by the formula below using the measurement values.

Coefficient of moisture expansion [% RH]={(L₁−L₀)/L₀}/(R₁−R₀)

[Modulus of Elasticity]

While the modulus of elasticity of the polymer film is not particularly limited, 1 to 50 GPa is preferable, 5 to 50 GPa is more preferable, and 7 to 20 GPa is even more preferable. The modulus of elasticity can be controlled by the type of polymer and the types, amounts, and elongation of additives.

Here, the modulus of elasticity is the tensile modulus of elasticity that is found from the initial gradient of a stress-distortion curve by preparing a film sample with a length of 150 mm and a width of 10 mm, conditioning the humidity of the sample for 24 hours at 25° C. and a relative humidity of 60%, and measuring the sample with an initial sample length of 100 mm and a tension rate of 10 mm/min in accordance with the standard of ISO527-3:1995. While the modulus of elasticity generally differs according to the manner in which the film sample is taken in the length direction and the width direction, in the present invention, having prepared the film sample, a value that is measured in a direction in which the modulus of elasticity is greatest is taken as the modulus of elasticity. Here, when the modulus of elasticity in a direction in which the speed of sound is greatest is E1 and the modulus of elasticity in a direction that is orthogonal thereto is E2, from the viewpoint of minimizing changes in dimensions while also maintaining the flexibility of the film, the ratio therebetween (E1/E2) is preferably 1.1 to 5.0 and more preferably 1.5 to 3.0.

Here, in the present invention, the direction in which the speed of sound (sound wave propagation speed) is greatest was found by conditioning the humidity of the film for 24 hours at 25° C. and a relative humidity of 60% and finding the direction in which the propagation speed of longitudinal wave vibrations of the ultrasonic pulses is greatest using an orientation measuring device (SST-2500: manufactured by Nomura Shoji Co., Ltd.).

[All-Optical Transmittance, Haze]

In the present invention, the value that is measured using a hazemeter (NDH 2000: manufactured by Nippon Denshoku Industries Co., Ltd.) after conditioning the humidity of the sample for 24 hours at 25° C. and a relative humidity of 60% is the all-optical transmittance and haze.

From the viewpoint of using light from a light source efficiently to reduce the power consumption of a panel, the all-optical transmittance of the polymer film is preferably high, and specifically, is preferably equal to or greater than 85%, more preferably equal to or greater than 90%, and even more preferably equal to or greater than 92%. Further, the haze of the film of the present invention is preferably equal to or less than 5%, more preferably equal to or less than 3%, even more preferably equal to or less than 2%, still even more preferably equal to or less than 1%, and particularly preferably equal to or less than 0.5%.

[Tear Strength]

In the present invention, samples of 64 mm×50 mm were respectively cut out with the direction that is parallel to the slow axis of the film and the direction that is orthogonal thereto as the longitudinal directions, and after conditioning the humidity of the samples for two hours at 25° C. and a relative humidity of 60%, the tear strength (Elmendorf tearing method) was measured using a light load tear strength testing device, and the smaller value was taken as the tear strength of the film.

Due to the fragility of the film, the tear strength of the polymer film is preferably 3 to 50 g, more preferably 5 to 40 g, and even more preferably 10 to 30 g.

[Film Thickness]

From the viewpoint of lowering manufacturing cost, the thickness of the polymer film is preferably 10 to 1000 μm, more preferably 40 to 500 and even more preferably 40 to 200 μm.

<Ultraviolet Absorber>

In the present invention, it is preferable that any of the layers that configure the optical film include an ultraviolet absorber. Furthermore, it is preferable that a layer on the viewing side of the optically anisotropic layer include an ultraviolet absorber. It is also preferable that an ultraviolet absorber be included in one or both of the polarizing film protective film and the base material film. As an ultraviolet absorber, a compound with absorption for an ultraviolet region of 200 to 400 nm which lowers both the |Re (400)−Re (700)| and the |Rth (400)−Rth (700)| is preferable. For example, a ratio of 0.01 to 30 mass % with respect to the solid content of the cellulose acylate can be added.

From the viewpoint of the flexibility of the ultraviolet absorber it is preferable that the molecular weight be 250 to 1000. The molecular weight is more preferably 260 to 800, even more preferably 270 to 800, and particularly preferably 300 to 800. As long as the molecular weight is within such ranges, the ultraviolet absorber may have a specific monomer structure, an oligomer structure in which a plurality of such monomer units are linked, or a polymer structure.

Specific examples of ultraviolet absorbers include the compounds described in [0059] to [0135] of JP2006-199855A.

Next, uses of the optical film of the present invention will be described. A first use of the optical film of the present invention is in security products.

The security product of the present invention is including the optical phase different element described above. That is, the optically anisotropic layer that is formed on the support includes at least three regions with slow phase layers and in-plane retardations that are different from one another, that is, the optically anisotropic layer includes three more regions on which respectively different pieces of polarization information are recorded. While the human eye recognizes brightness and colors by the total amount of light that is transmitted or reflected, the human eye cannot tell whether the light is natural light or polarized light. By observing the security product of the present invention through a polarizing film or by irradiating linearly polarized light, the latent polarization information is recognized.

Description will be given in more detail.

While the total amount of light that is transmitted or reflected on all faces of the security product of the present invention is the same, since the optically anisotropic layer that is included in the security product includes three or more types of regions with different slow axes and in-plane retardations, polarization information such as the fact that light that is transmitted or reflected on one region has more polarization components in the vertical direction and light that is transmitted or reflected on another region has more polarization components in the horizontal direction is recorded. Therefore, by observing through the polarizing film or irradiation linearly polarized light, it is possible for only linearly polarized light in a given direction to reach the human eye. That is, the latent recorded polarization information can be recognized. Since such information cannot be duplicated through copying by a copier or the like, if a security product that uses this principle is adhered to, for example, cash vouchers, securities, certificates of titles, identification documents, tickets, and cards, simple authentication determination is possible by observing through the polarizing film or the irradiation of linearly polarized light.

In particular, using two optical films of the present invention, making at least one of the optical films movable, and adjusting the light transmission amount along with the movement, a more complex latent image is possible, and a high counterfeit prevention effect can be expected. In a case when two optical films are used, it is preferable that the absorption axes of the polarizing films of the respective optical films be orthogonal and each phase difference region of the pattern optically anisotropic layer 10 be combined in an inverted state.

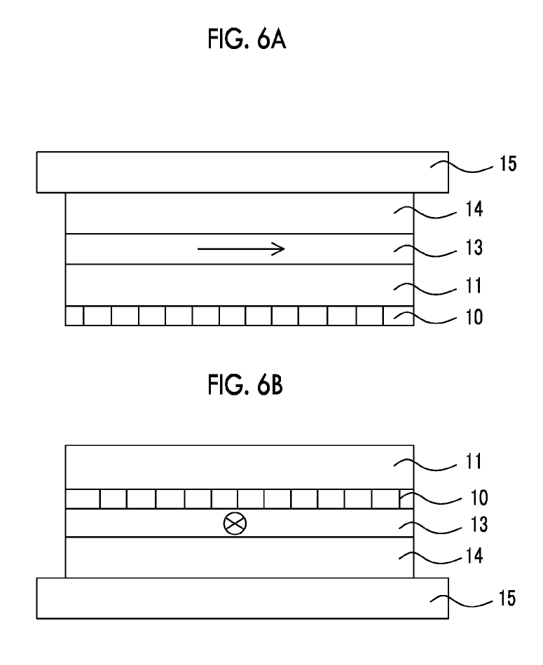

For example, in the embodiment illustrated in FIG. 6, two optical films (1) and (2) are respectively provided on a glass substrate 15. The optical film (1) has the glass substrate 15, the polarizing film protective film 14, the polarizing film 13, the transparent support 11, and the pattern anisotropic layer 10 laminated in that order. Here, the glass substrate 15 and the polarizing film protective 14, and the transparent support 11 and the polarizing film 13, for example, can be bonded together using an adhesive (not shown). Further, there may also be a case when an oriented film is included between the transparent support 11 and the optically anisotropic layer 10. The absorption axis of the polarizing film of the optical film (1) is set to be orthogonal to the stripes of the pattern optically anisotropic layer 10. On the other hand, the optical film (2) has the glass substrate 15, the polarizing film protective film 14, the polarizing film 13, the pattern optically anisotropic layer 10, and the transparent support 11 laminated in that order. Here, the glass substrate and the base material film 11, and the pattern optically anisotropic layer 10 and the polarizing film, for example, can be bonded together using an adhesive (not shown). Further, there may also be a case when an oriented film is included between the transparent support and the optically anisotropic layer 10. The absorption axis of the polarizing film of the optical film (2) is set to be parallel to the stripes of the pattern optically anisotropic layer 10.

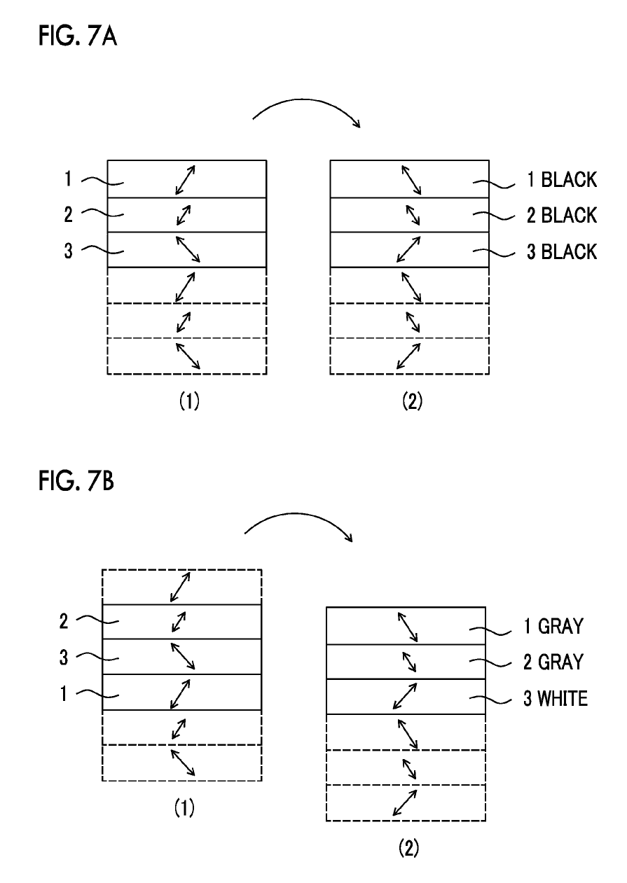

An example of a state in which each phase difference region of the pattern optically anisotropic layer is inverted is illustrated in FIG. 7A. In such a state, since the respective slow phase axes have an orthogonal relationship and the Re's match, all regions display black. Furthermore, a state in which the pattern is slid (moved) by one region is FIG. 7B. In the state of FIG. 7B, between the first phase difference region of the optical film (1) and the third phase difference region of the optical film (2), the Re's are the same and the slow axes are parallel, and since the Re's are the same, white is displayed, and the remaining regions display gray. Therefore, by sliding the pattern in the film face direction, the two combined optical films are able to achieve different Re's for each phase difference region of the pattern optically anisotropic layer and can adjust the light transmission amount.

Further, as described above, by attaching the security product as a label by providing an adhesive layer or as a transfer foil by providing a peeling layer and a heat sticker layer on computer software, video software, music CDs, and the like, the security product can be used as proof that a product is not a counterfeit.

Further, aside from the description above, the present invention may also be used as a window dimming system. In a case when the present invention is used as a window dimming system, if two optical films of the present invention are used, the amount of light that is incident can be adjusted by adjusting the manner in which the phase difference regions overlap.

### EXAMPLES

The present invention will be described more specifically below in terms of Examples. The materials, use amounts, ratios, processing contents, processing procedures, and the like indicated in the Examples below may be changed as appropriate without departing from the gist of the present invention. Therefore, the scope of the present invention is not limited to the specific examples shown below.

### Example 1

### Creation of Transparent Support A

A cellulose acylate solution A was prepared by loading the composition below into a mixing tank, stirring while heating, and dissolving each component.

Composition of Cellulose Acylate Solution A

| | | |
|---|---|---|
| Cellulose acetate with a degree of substitution of 2.86 | 100 | parts by mass |
| Triphenyl phosphate (plasticizer) | 7.8 | parts by mass |
| Biphenyl diphenyl phosphate (plasticizer) | 3.9 | parts by mass |
| Compound UV-1 (ultraviolet absorber) | 0.2 | parts by mass |
| Compound UV-2 (ultraviolet absorber) | 0.2 | parts by mass |
| Compound UV-3 (ultraviolet absorber) | 0.2 | parts by mass |
| Methylene chloride (first solvent) | 300 | parts by mass |
| Methanol (second solvent) | 54 | parts by mass |
| 1-Butanol | 11 | parts by mass |

Compound UV-1
[Chem. 11] 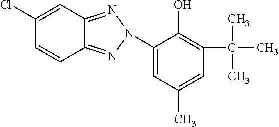 [SMILES: Cc1cc(-n2nc3ccc(Cl)cc3n2)c(O)c(C(C)(C)C)c1]
Compound UV-2
[Chem. 12] 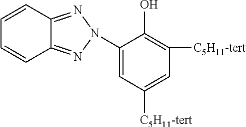
Compound UV-3
[Chem. 13]

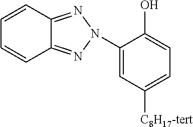

<<Creation of Cellulose Acetate Transparent Support>>

The cellulose acylate solution A was cast from a casting opening onto a drum that was cooled to 0° C. The cellulose acylate solution A was peeled in a state in which the solvent content is 70 mass %, both ends of the film in the width direction were fixed by a pin tenter (the pin tenter described in FIG. 3 of JP1992-1009A (JP-H04-1009A)), and the film was dried while maintaining an interval such that the stretching rate in the side direction (a direction that is perpendicular to the machine direction) was 7% in a state in which the solvent content was 3 to 5 mass %. The film was then dried further by being transported between the rollers of a heat processing device to create a cellulose acetate protective film (transparent support A) with a thickness of 80 μm. The transparent support A contains an ultraviolet absorber, the Re (550) was 1 nm and the Rth (550) was 40 nm.

<<Alkaline Saponification Process>>

After the cellulose acetate transparent support A was passed through dielectric heating rollers at a temperature of 60° C. and the surface temperature of the film was raised to 40° C., an alkaline solution with the composition shown below was applied to one face of the film using a bar coater with a coating amount of 14 ml/m², heated to 110° C., and transported under a steam type far infrared heater manufactured by Noritake Co., Ltd. for 10 seconds. Next, 3 ml/m² of deionized water was similarly applied using a bar coater. Next, after repeating rinsing using a fountain coater and draining using an air knife three times, the film was transported to a 70° C. drying zone for 10 seconds and dried to create a cellulose acetate transparent support A on which an alkaline saponification process has been performed.

Composition of Alkaline Solution (Parts by Mass)

| | | |
|---|---|---|
| Potassium hydroxide | 4.7 | parts by mass |
| Water | 15.8 | parts by mass |
| Isopropanol | 63.7 | parts by mass |
| Surfactant | 1.0 | parts by mass |
| SF-1: C₁₄H₂₉O (CH₂CH₂O)₂₀H | | |
| Propylene glycol | 14.8 | parts by mass |

<Creation of Transparent Support with Rubbing Oriented Film>

A rubbing oriented film coating liquid with the composition described below was continuously applied using a #8 wire bar on the face of the created support on which the saponification process has been performed. An oriented film was formed by drying the oriented film coating liquid with warm air at 60° C. for 60 seconds and with warm air at 100° C. for 120 seconds. Next, by arranging a stripe mask with a horizontal stripe width of a first transmission portion of 285 μm, a horizontal stripe width of a second transmission portion of 285 μm, and a horizontal stripe width of a blocking portion of 285 μm on the rubbing oriented film, irradiating ultraviolet rays for 40 seconds using an air cooling metal halide lamp (manufactured by Eye Graphics Co., Ltd.) with a brightness of 2.5 mW/cm² in the UV-C region at room temperature, and generating an acidic compound by disintegrating the photoacid generator, an oriented layer for the first phase difference region, the second phase difference region, and the third phase difference region were formed. Here, the stripe mask is a halftone mask, and the'transmittance of light in the UV-C region of the first transmission portion was approximately 10%, and the transmittance of the second transmission portion was equal to or greater than 90%.

Finally, the transparent support with the rubbing oriented film was created by performing a rubbing process once back and forth in one direction at 500 rpm while maintaining an angle of 45° with respect to the stripes of the stripe mask. Here, the film thickness of the oriented film was 0.5 μm. When regions in the oriented film that respectively correspond to the first phase difference region, the second phase difference region, and the third phase difference region after the patterning of the oriented film were analyzed using TOF-SIMS (flight time type secondary ion mass analysis method, TOF-SIMS V manufactured by ION-TOF GmbH), it was found that in the corresponding regions, the abundance ratio of the photoacid generator S-2 within the corresponding oriented film was 40 to 2 to 92, and that approximately 60% of S-2 was disintegrated in the first phase difference region and almost all S-2 was disintegrated in the second phase difference region.

Composition of Oriented Film Formation Application Liquid

| | | |
|---|---|---|
| Oriented film polymer material | 3.9 | parts by mass |
| (PVA103, polyvinyl alcohol manufactured by Kuraray | | |
| Co., Ltd.) | | |
| Photoacid generator (S-2) | 0.1 | parts by mass |
| Methanol | 36 | parts by mass |
| Water | 60 | parts by mass |

Photoacid Generating Agent S-2
[Chem. 14]

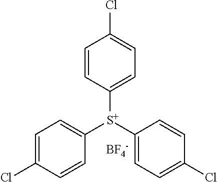

<Creation of Patterned Optically Anisotropic Layer A>

The optically anisotropic layer coating liquid below was applied using a bar coater with a coating amount of 4 ml/m². Next, the pattern optically anisotropic layer A was formed by heating and curing the coating liquid for 2 minutes at a film surface temperature of 110° C., cooling the coating liquid to 80° C., and irradiating ultraviolet rays for 20 seconds using an air cooling metal halide lamp (manufactured by Eye Graphics Co., Ltd.) at 20 mW/cm² to fix the orientation state. A discotic liquid crystal was vertically oriented with the slow axis direction parallel to the rubbing direction in the first transmission portion (first phase difference region), had a hybrid orientation with the slow phase direction orthogonal to the rubbing direction in the second transmission portion (second phase difference region), and was vertically oriented orthogonally in the unexposed portion (third phase difference region). Here, the film thickness of the optically anisotropic layer was 0.9 p.m.

Composition of Optically Anisotropic Layer Application Liquid

| | | |
|---|---|---|
| Discotic liquid crystal E-1 | 100 | parts by mass |
| Oriented film interface orientation agent (II-1) | 3.0 | parts by mass |
| Air interface orientation agent (P-1) | 0.4 | parts by mass |
| Photopolymerization initiator (IRGACURE 907 manufactured by Ciba Specialty | 3.0 | parts by mass |
| Chemicals Co., Ltd.) | | |
| Sensitizer (KAYACURE-DETX manufactured by Nippon Kayaku Co., Ltd.) | 1.0 | parts by mass |
| Methyl ethyl ketone | 400 | parts by mass |

Discotic Liquid Crystal E-1
[Chem. 15] 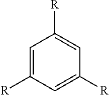 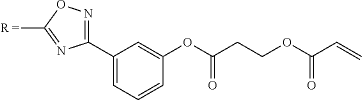
Oriented Film Interface Orientation Agent (II-1)
[Chem. 16] 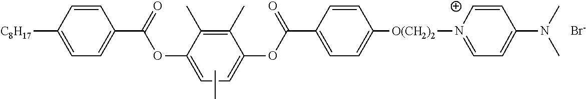
Air Interface Orientation Agent (P-1)
[Chem. 17] 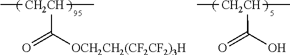
Mw. 13000

Further, it was found that in the optically anisotropic layer, II-1 cations and BE₄⁻ anions of the acid HBF₄ which are generated from the photoacid generator S-2 were present in the air interfaces of the first phase difference region and the second phase difference region. Hardly any of such ions were observed in the third phase difference region, and it was found that the II-1 cations and Br⁻ were present in the vicinity of the oriented film interface. The abundance ratio of the respective ions in the air interface was 50 to 93 to 7 for the II-1 cations and 46 to 90 to 10 for BF₄⁻. From this, it was found that while the oriented film interface orientation agent (II-1) is unevenly distributed in the oriented film interface in the third phase difference region, the uneven distribution is reduced in the first phase difference region and the orientation agent is also dispersed in the air interface, and the unevenness is greatly reduced in the second phase difference region and the orientation agent is mostly dispersed in the air interface. It can be understood that in the first phase difference region and the second phase difference region, through the acid HBF₄ and II-1 that are generated being anionically exchanged, the dispersion of the II-1 cations is promoted.

(Evaluation of Optically Anisotropic Layer)

After the created optically anisotropic layer was peeled from the transparent support, the orientation of the discotic liquid crystal in the oriented film interface, the orientation of the discotic liquid crystal in the air interface, the direction of the slow axis, and the Re were respectively measured according to the method described above using a KOBRA-21ADH (manufactured by Oji Scientific Instruments Co., Ltd.). The results are shown in Table 1. In the table, “vertical” denotes a tilt angle of 70° to 90°.

From the results shown in Table 1, it can be understood that by causing the discotic liquid crystal to be oriented on an oriented film on which a rubbing process has been performed in one direction after performing halftone mask exposure on a PVA-based rubbing oriented film that contains a photoacid generator in the presence of a pyridinium compound and a fluoroaliphatic group-containing copolymer, a patterned optically anisotropic layer that includes a first phase difference region and a third phase difference region with vertical orientation and in which the slow axes are orthogonal and a second phase difference region with a hybrid orientation is obtained.

<Creation of Polarizing Plate A>

Using TD80UL (manufactured by Fujifilm Corporation, Re/Rth=2/40 at 550 nm) as a polarizing plate A protective film A, an alkaline saponification process was performed on the surface thereof. The film was soaked in a 1.5-regulated sodium hydroxide aqueous solution at 55° C. for 2 minutes, washed in a washing tub at room temperature, and neutralized using 0.1-regulatedsulfuric acid at 30° C. The film was washed in the washing tub once again and dried using warm air at 100° C.

Next, a roll-shaped polyvinyl alcohol film with a thickness of 80 μm was continuously stretched by a factor of 5 in an iodine aqueous solution and dried to obtain a polarizing film with a thickness of 20 μm. The saponification face of the alkaline saponification-processed TD80UL and the polyvinyl alcohol film were bonded together with an aqueous solution with 3% polyvinyl alcohol (PVA-117H manufactured by Kuraray Co., Ltd.) as an adhesive and the face of the patterned optically anisotropic layer A and the polyvinyl alcohol film were bonded together using the adhesive to create a polarizing plate A in which the TD80UL and the patterned optically anisotropic layer A are the protective film of the polarizing film. At this point, the angle between the slow axis of the phase difference film and the absorption axis of the polarizing film was 45° and the stripes of the phase difference film and the absorption axis were parallel.

### Example 2

### Transparent Support B

TD80UL (manufactured by Fujifilm Corporation) was prepared and used as a transparent support B. The film thickness of TD80UL was 80 μm, TD80UL contained an ultraviolet absorber, the in-plane retardation Re (550) was 2 nm, and the thickness-direction retardation Rth (550) was 40 nm.

<Creation of Patterned Optical Anisotropic Layer B>

The creation of a patterned optically anisotropic layer B was performed using the same operation as in Example 1 except that the transparent support A was changed to the transparent support B and the rubbing oriented film coating liquid was changed to the composition below. Here, the film thickness of the oriented film was 0.5 μm and the film thickness of the optically anisotropic layer was 0.9

Orientation Layer Composition

| | | |
|---|---|---|
| Oriented film polymer material | 3.9 | parts by mass |
| (PVA103, polyvinyl alcohol manufactured by Kuraray | | |
| Co., Ltd.) | | |
| Photoacid generator (I-33) | 0.1 | parts by mass |
| Methanol | 36 | parts by mass |
| Water | 60 | parts by mass |

Photoacid Generating Agent I-33
[Chem. 18] 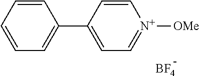
*Me: methyl

When the first phase difference region, the second phase difference region, and the third phase difference region of the pattern optically anisotropic layer A that was formed were analyzed using TOF-SIMS (time of flight type secondary ion mass analysis method, TOF-SIMS V manufactured by ION-TOF GmbH), it was found that in the first phase difference region, the second phase difference region, and the third phase difference region, the abundance ratio of the photoacid generator I-33 in the corresponding oriented film was 32 to 2 to 92, and that approximately 70% of I-33 was disintegrated in the first phase difference region and almost all I-33 was disintegrated in the second phase difference region. Further, it was found that in the optically anisotropic layer, II-1 cations and anions BF₄⁻ of the acid HBF₄ which are generated from the photoacid generator I-33 were present in the air interfaces of the first phase difference region and the second phase difference region. Hardly any of such ions were observed in the third phase difference region, and it was found that the II-1 cations and Br⁻ were present in the vicinity of the oriented film interface. The abundance ratio of the respective ions in the air interface was 60 to 93 to 7 for the II-1 cations and 55 to 90 to 4 for BF₄⁻. From this, it was found that while the oriented film interface orientation agent (II-1) is unevenly distributed in the oriented film interface in the third phase difference region, the uneven distribution is reduced in the first phase difference region and the orientation agent is also dispersed in the air interface, and the unevenness is greatly reduced in the second phase difference region and the orientation agent is mostly dispersed in the air interface. It can be understood that in the first phase difference region and the third phase difference region, through the acid HBF₄ and II-1 that are generated being anionically exchanged, the dispersion of the II-1 cations is promoted.

(Evaluation of Optically Anisotropic Layer)

After the created optically anisotropic layer B was peeled from the transparent support B, the orientation of the discotic liquid crystal in the oriented film interface, the orientation of the discotic liquid crystal in the air interface, the direction of the slow axis, and the Re were respectively measured according to the method described above using a KOBRA-21ADH (manufactured by Oji Scientific Instruments Co., Ltd.). The results are shown in Table 1. In the table, “vertical” denotes a tilt angle of 70° to 90°.

From the results shown in Table 1, it can be understood that by causing the discotic liquid crystal to be oriented on an oriented film that is rubbing processed in one direction after exposing a halftone mask on a PVA-based rubbing oriented film that contains a photoacid generator in the presence of a pyridinium salt compound and a fluoroaliphatic group-containing copolymer, a patterned optically anisotropic layer that includes a first phase difference region and a third phase difference region with vertical orientation and in which the slow axes are orthogonal and a second phase difference region with a hybrid orientation is obtained.

<Creation of Polarizing Plate B>

A polarizing plate B was created by bonding together the face of the created pattern optically anisotropic layer B and the face of the polyvinyl alcohol film of the polarizing plate A created in Example 1 using an adhesive. At this point, the angle between the slow axis of the patterned optically anisotropic layer B and the absorption axis of the polarizing film was ±45° and the stripes of the optically anisotropic layer B and the absorption axis were parallel.

### Example 3

### Creation of Patterned Optically Anisotropic Layer C

The creation of a patterned optically anisotropic layer C was performed using the same operations as in Example 2 except that the halftone mask was changed so that the light transmittance in the UV-C region of the first transmission portion was approximately 10% and the transmittance in the second transmission portion was approximately 60%. Here, the film thickness of the oriented film was 0.5 μm and the film thickness of the optically anisotropic layer was 0.9 μm.

When the first phase difference region, the second phase difference region, and the third phase difference region of the pattern optically anisotropic layer C that was formed were analyzed using TOF-SIMS (time of flight type secondary ion mass analysis method, TOF-SIMS V manufactured by ION-TOF GmbH), it was found that in the first phase difference region, the second phase difference region, and the third phase difference region, the abundance ratio of the photoacid generator I-33 in the corresponding oriented film was 32 to 15 to 92, and that approximately 70% of I-33 was disintegrated in the first phase difference region and approximately 80% of I-33 was disintegrated in the second phase difference region. Further, it was found that in the optically anisotropic layer, II-1 cations and anions BF₄⁻ of the acid HBF₄ which are generated from the photoacid generator I-33 were present in the air interfaces of the first phase difference region and the second phase difference region. Hardly any of such ions were observed in the third phase difference region, and it was found that the II-1 cations and Br⁻ were present in the vicinity of the oriented film interface. The abundance ratio of the respective ions in the air interface was 60 to 80 to 7 for the II-1 cations and 55 to 80 to 4 for BF₄⁻. From this, it was found that while the oriented film interface orientation agent (II-1) is unevenly distributed in the oriented film interface in the third phase difference region, the uneven distribution is reduced in the first phase difference region and the orientation agent is also dispersed in the air interface, and the unevenness is greatly reduced in the second phase difference region and approximately 80% of the orientation agent is dispersed in the air interface. It can be understood that in the first phase difference region and the second phase difference region, through the acid HBF₄ and II-1 that are generated being anionically exchanged, the dispersion of the II-1 cations is promoted.

(Evaluation of Optically Anisotropic Layer)

After the created optically anisotropic layer C was peeled from the transparent support B, the orientation of the discotic liquid crystal in the oriented film interface, the orientation of the discotic liquid crystal in the air interface, the direction of the slow axis, and the Re were respectively measured according to the method described above using a KOBRA-21ADH (manufactured by Oji Scientific Instruments Co., Ltd.). The results are shown in Table 1. In the table, “vertical” denotes a tilt angle of 70° to 90°.

From the results shown in Table 1, it can be understood that by causing the discotic liquid crystal to be oriented on an oriented film that is rubbing processed in one direction after exposing a halftone mask on a PVA-based rubbing oriented film that contains a photoacid generator in the presence of a pyridinium salt compound and a fluoroaliphatic group-containing copolymer, a patterned optically anisotropic layer that includes a first phase difference region and a third phase difference region with vertical orientation and in which the slow axes are orthogonal and a second phase difference region with a hybrid orientation is obtained.

<Creation of Polarizing Plate C>

A polarizing plate C was created by bonding together the face of the created pattern optically anisotropic layer C and the face of the polyvinyl alcohol film of the polarizing plate A created in Example 1 using an adhesive. At this point, the angle between the slow axis of the patterned optically anisotropic layer C and the absorption axis of the polarizing film was ±45° and the stripes of the optically anisotropic layer C and the absorption axis were parallel.

### Example 4

### Transparent Support B

TD80UL (manufactured by Fujifilm Corporation) was prepared and used as the transparent support B. The film thickness of TD80UL was 80 μm, TD80UL contained an ultraviolet absorber, the in-plane retardation Re (550) was 2 nm, and the thickness-direction retardation Rth (550) was 40 nm.

<Creation of Transparent Support with Optically Oriented Film>

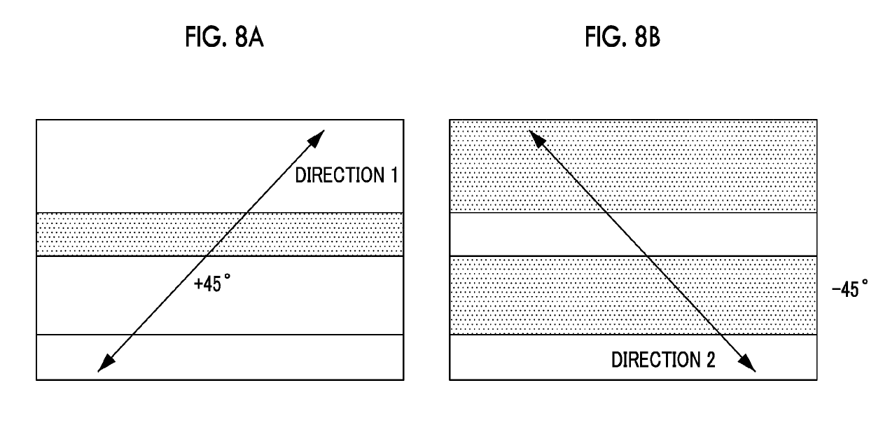

A 1% aqueous solution of the optically oriented material E-1 with the structure below was applied to the transparent support B and dried for one minute at 100° C. Ultraviolet rays were irradiated on the obtained coating film using an air cooling metal halide lamp (manufactured by Eye Graphics Co., Ltd.) at 160 W/cm² in air. At this time, exposure was performed through a mask A (striped mask in which the horizontal stripe width in the transmission portion is 570 μm and the horizontal stripe width of the blocking portion is 285 μm) by setting a wire grid polarizer (ProFlux PPLO2 manufactured by Moxtek Inc.) in direction 1 as illustrated in FIG. 8A. Exposure was then performed through a mask B (striped mask in which the horizontal stripe width in the transmission portion is 285 μm and the horizontal stripe width of the blocking portion is 570 μm) by setting the wire grid polarizer in direction 2 as illustrated in FIG. 8B. The distance between the exposure mask face and the optically oriented film 1 was set to 200 μm. The illuminance of the ultraviolet rays used at this time was 100 mW/cm² in the UV-A region (estimated wavelength of 380 nm to 320 nm) and the irradiation amount was 1000 mJ/cm² in the UV-A region.

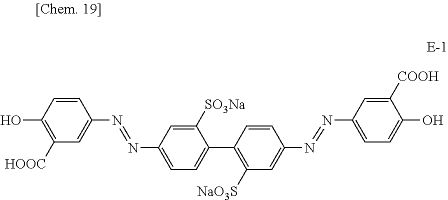

<Creation of Patterned Optically Anisotropic Layer D>

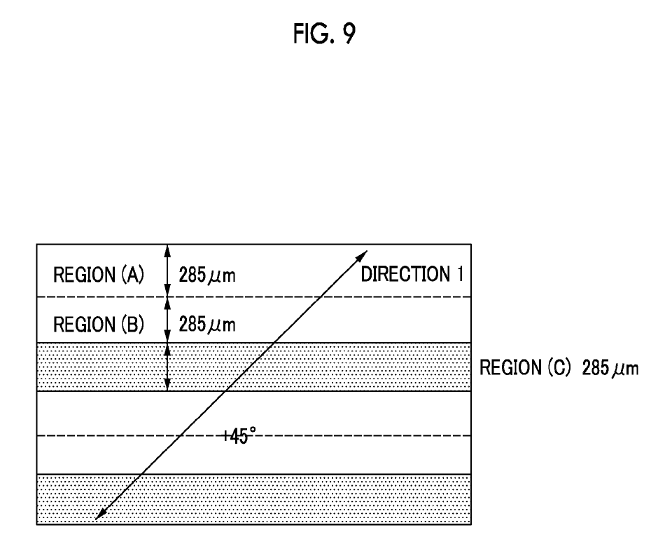

After the optically anisotropic layer composition below was prepared, the composition was filtered using a propylene filter with hole diameters of 0.2 μm and used as a coating liquid. After applying the coating liquid on the transparent support A with the optically oriented film and drying the film surface temperature for 2 minutes at 105° C. to create a liquid crystal phase state, the orientation state was fixed by cooling the film to 75° C. and irradiating ultraviolet rays using an air cooling metal halide lamp (manufactured by Eye Graphics Co., Ltd.) at 160 W/cm² in air. At this time, as illustrated in FIG. 9, first, after mask exposing the region (A) of the transmission portion and the region (C) of the blocking portion illustrated in FIG. 8A to fix the orientation state, the film was further heated to 95° C. and the remaining region (B) of the unexposed portion was exposed to fix the orientation state. A patterned optically anisotropic layer D was created in such a manner. The film thickness of the optically anisotropic layer was 1.3 μm.

Composition of Optically Anisotropic Layer

| | | |
|---|---|---|
| Rod-like liquid crystal (LC242, manufactured by BASF SE) | 100 | parts by mass |
| Air interface orientation agent A | 0.3 | parts by mass |
| Photopolymerization initiator (IRGACURE 907 manufactured by Ciba Specialty Chemicals | 3.3 | parts by mass |
| Co., Ltd.) | | |
| Sensitizer (KAYACURE-DETX manufactured by Nippon Kayaku Co., Ltd.) | 1.1 | parts by mass |
| Methyl ethyl ketone | 300 | parts by mass |

Bar-like Liquid crystal LC242: Bar-like Liquid crystal described in WO2010/090429A2
[Chem. 20] 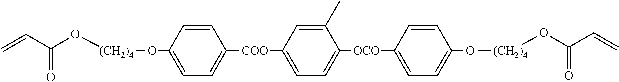
Horizontal Orientation Agent A
[Chem. 21]

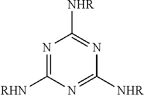

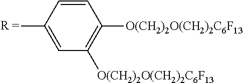

(Evaluation of Optically Anisotropic Layer)

After the created optically anisotropic layer D was peeled from the transparent support B, the orientation of the bar-like liquid crystal in the oriented film interface, the orientation of the bar-like liquid crystal in the air interface, the direction of the slow axis, and the Re were respectively measured according to the method described above using a KOBRA-21ADH (manufactured by Oji Scientific Instruments Co., Ltd.). The results are shown in Table 1. In the table, “horizontal” denotes a tilt angle of 0° to 20°.

From the results shown in Table 1, it can be understood that by causing the bar-like liquid crystal to be oriented in the presence of a polarization exposed optically oriented film and changing the temperature at which the orientation is fixed through ultraviolet irradiation, a patterned optically anisotropic layer that includes a first phase difference region and a third phase difference region with horizontal orientation and in which the slow axes are orthogonal and a second phase difference region with a horizontal orientation and in which the slow axis is the same as, and the in-plane retardation is different from, the first phase difference region is obtained.

<Creation of Polarizing Plate D>

A polarizing plate D was created by bonding together the face of the created pattern optically anisotropic layer D and the face of the polyvinyl alcohol film of the polarizing plate A created in Example 1 using an adhesive. At this point, the angle between the slow axis of the patterned optically anisotropic layer D and the absorption axis of the polarizing film was ±45° and the stripes of the optically anisotropic layer C and the absorption axis were parallel.

### Example 5

### Creation of Transparent Support C

A cellulose acylate solution C was prepared by loading the composition below into a mixing tank and stirring while heating to dissolve each component.

Composition of Cellulose Acylate Solution C

| | | |
|---|---|---|
| Cellulose acetate with a degree of substitution of 2.86 | 100 | parts by mass |
| Triphenyl phosphate (plasticizer) | 7.8 | parts by mass |
| Biphenyl diphenyl phosphate (plasticizer) | 3.9 | parts by mass |
| Methylene chloride (first solvent) | 300 | parts by mass |
| Methanol (second solvent) | 54 | parts by mass |
| 1-Butanol | 11 | parts by mass |

An additive solution B was prepared by loading the composition below
into a different mixing tank and stirring while heating to dissolve each
component.
Composition of Additive Solution B

| | | |
|---|---|---|
| Compound B1 (Re lowering agent) | 40 | parts by mass |
| Compound B2 (wavelength dispersion controlling | 4 | parts by mass |
| agent) | | |
| Methylene chloride (first solvent) | 80 | parts by mass |
| Methanol (second solvent) | 20 | parts by mass |

Compound B1
[Chem. 22] 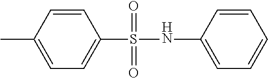 [SMILES: Cc1ccc(S(=O)(=O)Nc2ccccc2)cc1]
Compound B2
[Chem. 23]

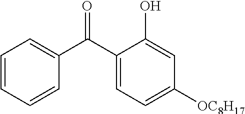

<<Creation of Cellulose Acetate Transparent Support C>>

A dope was prepared by adding 477 parts by mass of the cellulose acylate solution C to 40 parts by mass of the additive solution B and sufficiently stirred. The dope was cast from a casting opening onto a drum that was cooled to 0° C. The cellulose acylate solution A was peeled in a state in which the solvent content is 70 mass %, both ends of the film in the width direction were fixed by a pin tenter (the pin tenter described in FIG. 3 of JP-H04-1009A), and the film was dried while maintaining an interval such that the stretching rate in the side direction (a direction that is perpendicular to the machine direction) was 3% in a state in which the solvent content was 3 to 5 mass %. The film was then dried further by being transported between the rollers of a heat processing device to create a cellulose acetate protective film (transparent support C) with a thickness of 60 μm. The transparent support A contains an ultraviolet absorber, the Re (550) was 0 nm and the Rth (550) was 12.3 nm.

### <<Alkaline Saponification Process>>

After the cellulose acetate transparent support C was passed through dielectric heating rollers at a temperature of 60° C. and the surface temperature of the film was raised to 40° C., an alkaline solution with the composition shown below was applied to one face of the film using a bar coater with a coating amount of 14 ml/m², heated to 110° C., and transported under a steam type infrared heater manufactured by Noritake Co., Ltd. for 10 seconds. Next, 3 ml/m² of deionized water was similarly applied using a bar coater. Next, after repeating rinsing using a fountain coater and draining using an air knife three times, the film was transported to a 70° C. drying zone for 10 seconds and dried to create a cellulose acetate transparent support C on which an alkaline saponification process has been performed.

Composition of Alkaline Solution (Parts by Mass)

| | | |
|---|---|---|
| Potassium hydroxide | 4.7 | parts by mass |
| Water | 15.8 | parts by mass |
| Isopropanol | 63.7 | parts by mass |
| Surfactant | 1.0 | parts by mass |
| SF-1: C₁₄H₂₉O (CH₂CH₂O)₂₀H | | |
| Propylene glycol | 14.8 | parts by mass |

<Creation of Patterned Optically Anisotropic Layer E>

The creation of a patterned optically anisotropic layer E was performed using the same operations as in Example 1 except that the transparent support A was changed to the transparent support C. Here, the film thickness of the oriented film was 0.5 μm and the film thickness of the optically anisotropic layer was 0.9 μm.

(Evaluation of Optically Anisotropic Layer)

After the created optically anisotropic layer E was peeled from the transparent support C, the orientation of the discotic liquid crystal in the oriented film interface, the orientation of the discotic liquid crystal in the air interface, the direction of the slow axis, and the Re were respectively measured according to the method described above using a KOBRA-21ADH (manufactured by Oji Scientific Instruments Co., Ltd.). The results are shown in Table 1. In the table, “vertical” denotes a tilt angle of 70° to 90°.

From the results shown in Table 1, it can be understood that by causing the discotic liquid crystal to be oriented on an oriented film that is rubbing processed in one direction after exposing a halftone mask on a PVA-based rubbing oriented film that contains a photoacid generator in the presence of a pyridinium salt compound and a fluoroaliphatic group-containing copolymer, a patterned optically anisotropic layer that includes a first phase difference region and a third phase difference region with vertical orientation and in which the slow axes are orthogonal and a second phase difference region with a hybrid orientation is obtained.

<Creation of Polarizing Plate E>

A polarizing plate E was created by bonding together the face of the created pattern optically anisotropic layer E and the face of the polyvinyl alcohol film of the polarizing plate A created in Example 1 using an adhesive. At this point, the angle between the slow axis of the patterned optically anisotropic layer E and the absorption axis of the polarizing film was ±45° and the stripes of the optically anisotropic layer E and the absorption axis were parallel.

### Example 6

### Transparent Support B

TD80UL (manufactured by Fujifilm Corporation) was prepared and used as the transparent support B. The film thickness of TD80UL was 80 μm, TD80UL contained an ultraviolet absorber, the in-plane retardation Re (550) was 2 nm, and the thickness-direction retardation Rth (550) was 40 nm.

<Creation of Patterned Optically Anisotropic Layer F>

The creation of a patterned optically anisotropic layer F was performed using the same operations as in Example 1 except that the transparent support A was changed to the transparent support B and the optically anisotropic layer composition was changed to the composition below. Here, the film thickness of the oriented film was 0.5 μm and the film thickness of the optically anisotropic layer was 0.9 μm.

Composition of Optically Anisotropic Layer

| | | |
|---|---|---|
| Discotic liquid crystal E-3 | 100 | parts by mass |
| Oriented film interface orientation agent (II-1) | 3.0 | parts by mass |
| Air interface orientation agent (P-1) | 0.4 | parts by mass |
| Photopolymerization initiator | 3.0 | parts by mass |
| (IRGACURE 907 manufactured by Ciba Specialty | | |
| Chemicals Co., Ltd.) | | |
| Sensitizer (KAYACURE-DETX manufactured by | 1.0 | parts by mass |
| Nippon Kayaku Co., Ltd.) | | |
| Ethylene oxide-modified trimethylolpropane | 9.9 | parts by mass |
| triacrylate (V#360, manufactured by Osaka | | |
| Organic Chemical Industry Co., Ltd.) | | |
| Methyl ethyl ketone | 400 | parts by mass |

Discotic Liquid crystal E-3
[Chem. 24]

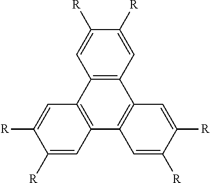

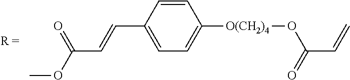

(Evaluation of Optically Anisotropic Layer)

After the created optically anisotropic layer F was peeled from the transparent support B, the orientation of the discotic liquid crystal in the oriented film interface, the orientation of the discotic liquid crystal in the air interface, the direction of the slow axis, and the Re were respectively measured according to the method described above using a KOBRA-21ADH (manufactured by Oji Scientific Instruments Co., Ltd.). The results are shown in Table 1. In the table, “vertical” denotes a tilt angle of 70° to 90°.

From the results shown in Table 1, it can be understood that by causing the discotic liquid crystal to be oriented on an oriented film that is rubbing processed in one direction after exposing a halftone mask on a PVA-based rubbing oriented film that contains a photoacid generator in the presence of a pyridinium salt compound and a fluoroaliphatic group-containing copolymer, a patterned optically anisotropic layer that includes a first phase difference region and a third phase difference region with vertical orientation and in which the slow axes are orthogonal and a second phase difference region with a hybrid orientation is obtained.

<Creation of Polarizing Plate F>

A polarizing plate F was created by bonding together the face of the created pattern optically anisotropic layer F and the face of the polyvinyl alcohol film of the polarizing plate A created in Example 1 using an adhesive. At this point, the angle between the slow axis of the patterned optically anisotropic layer F and the absorption axis of the polarizing film was ±45° and the stripes of the optically anisotropic layer F and the absorption axis were parallel.

### Example 7

### Creation of Polarizing Plate G

A polarizing plate G was created by changing the polarizing plate to a wire grid type polarizer and bonding together the face of the created pattern optically anisotropic layer A and TD80UK from both faces to interpose the wire grid therebetween using an adhesive. At this point, the angle between the slow axis of the patterned optically anisotropic layer A and the absorption axis of the wire grid was 45° and the stripes of the optically anisotropic layer A and the absorption axis were parallel.

### Comparative Example 1

### Creation of Patterned Optically Anisotropic Layer H

The creation of a patterned optically anisotropic layer H was performed using the same operations as in Example 1 except that the halftone mask was changed so that the light transmittance in the UV-C region of the first transmission portion was approximately 10% and the transmittance in the second transmission portion was approximately 10%. Here, the film thickness of the oriented film was 0.5 μm and the film thickness of the optically anisotropic layer was 0.9 μm.

(Evaluation of Optically Anisotropic Layer)

After the created optically anisotropic layer H was peeled from the transparent support A, the orientation of the discotic liquid crystal in the oriented film interface, the orientation of the discotic liquid crystal in the air interface, the direction of the slow axis, and the Re were respectively measured according to the method described above using a KOBRA-21ADH (manufactured by Oji Scientific Instruments Co., Ltd.). The results are shown in Table 1. In the table, “vertical” denotes a tilt angle of 70° to 90°.

From the results shown in Table 1, it can be understood that when the discotic liquid crystal is caused to be oriented on an oriented film that is rubbing processed in one direction after a halftone mask is exposed on a PVA-based rubbing oriented film that contains a photoacid generator in the presence of a pyridinium salt compound and a fluoroaliphatic group-containing copolymer, since the exposure amounts of the first transmission portion and the second transmission portion are the same, the slow axes of the first phase difference region and the second phase difference were parallel and the front retardations were also the same.

<Creation of Polarizing Plate H>

A polarizing plate H was created by bonding together the face of the created pattern optically anisotropic layer H and the face of the polyvinyl alcohol film of the polarizing plate A created in Example 1 using an adhesive. At this point, the angle between the slow axis of the patterned optically anisotropic layer H and the absorption axis of the polarizing film was ±45° and the stripes of the optically anisotropic layer H and the absorption axis were parallel.

(Evaluation)

<Evaluation of Security Product>

Results are shown in Table 1. Favorable evaluations are in order from A, B, C, to D. Even when observed in natural light as they were, each of the polarizing plates that were created was only identified as an even film. Next, in a case when an observation was made by holding a polarizing plate, when the absorption axis of the held polarizing plate was made to be orthogonal to the absorption axis of the security product, with the products of Examples 1, 2, 5, and 7, an image was able to be observed with high contrast since the Re difference of each region is large. On the other hand, in Comparative Example 1, since the Re values of each of the regions are the same and the circular polarization states thereof (while there were differences between left and right) are also the same, similarly to when an observation was made with natural light, the polarization plates were only identified as even films.

<Evaluation of Light Resistance>

Changes in the patterned optically anisotropy and changes in the degree of polarization of the polarizing plates were investigated before and after a light resistance test according to JIS K 5600-7-5 was conducted for 25 hours using a light resistance testing device (Super Xenon Weather Meter SX120 (long-life xenon lamp), manufactured by Suga Test Instruments Co., Ltd.) with conditions of an irradiance of 100±25 W/m² (wavelengths of 310 nm to 400 nm), a test tank temperature of 35±5° C., a black panel temperature of 50±5° C., and a relative humidity of 65±15%. A case when the change rate was within 5% was deemed A, within 10% deemed B, and any greater rates were deemed C. The results are shown in Table 1.

TABLE 1

| | | | | Oriented film | | Air interface | | | |
|---|---|---|---|---|---|---|---|---|---|
| | | | | orientation agent | | orientation agent | | Exposure | |
| | | | | | Addition | | Addition | | Mask |
| | Liquid | Oriented | Photoacid | Base | amount | Base | amount | Brightness | transmittance |
| | crystal | film | generator | material | (mass %) | material | (mass %) | (mW/cm²) | (%) |
| Example 1 | E-1 | PVA103 | S-2 | 3.0 | 0.4 | P-1 | 0.4 | 2.5 | 10 |
| | | | | | | | | | >90 |
| | | | | | | | | | 0 |
| Example 2 | E-1 | PVA103 | I-33 | 3.0 | 0.4 | P-1 | 0.4 | 2.5 | 10 |
| | | | | | | | | | >90 |
| | | | | | | | | | 0 |
| Example 3 | E-1 | PVA103 | I-33 | 3.0 | 0.4 | P-1 | 0.4 | 2.5 | 10 |
| | | | | | | | | | 60 |
| | | | | | | | | | 0 |
| Example 4 | LC242 | E-1 | — | — | — | A | 0.3 | FIG. 8A direction | |
| | | | | | | | | FIG. 8A direction | |
| | | | | | | | | FIG. 8A direction | |
| Example 5 | E-1 | PCA103 | S-2 | 3.0 | 0.4 | P-1 | 0.4 | 2.5 | 10 |
| | | | | | | | | | >90 |
| | | | | | | | | | 0 |
| Example 6 | E-3 | PVA103 | S-2 | 3.0 | 0.4 | P-1 | 0.4 | 2.5 | 10 |
| | | | | | | | | | >90 |
| | | | | | | | | | 0 |
| Example 7 | E-1 | PVA103 | S-2 | 3.0 | 0.4 | P-1 | 0.4 | 2.5 | 10 |
| | | | | | | | | | >90 |
| | | | | | | | | | 0 |
| Comparative | E-1 | PVA103 | S-2 | 3.0 | 0.4 | P-1 | 0.4 | 2.5 | 10 |
| Example 1 | | | | | | | | | 10 |
| | | | | | | | | | 0 |

| | Slow | | | Optical | | |
|---|---|---|---|---|---|---|
| | axis | | | characteristic | | |
| | direction | | | of optically | | |
| | (with | Orientation | | anisotropic | Result | |
| | respect to | Oriented | Air interface | layer | Security | Light |
| | stripes) | film side | face | Re (nm) | performance | resistance |
| Example 1 | +45° | Vertical | Vertical | 135 | A | B |
| | −45° | Hybrid | Hybrid | 75 | | |
| | −45° | Vertical | Vertical | 135 | | |
| Example 2 | +45° | Vertical | Vertical | 135 | A | B |
| | −45° | Hybrid | Hybrid | 75 | | |
| | −45° | Vertical | Vertical | 135 | | |
| Example 3 | +45° | Vertical | Vertical | 135 | B | B |
| | −45° | Hybrid | Hybrid | 90 | | |
| | −45° | Vertical | Vertical | 135 | | |
| Example 4 | −45° | Horizontal | Horizontal | 135 | C | B |
| | −45° | Horizontal | Horizontal | 100 | | |
| | +45° | Horizontal | Horizontal | 135 | | |
| Example 5 | +45° | Vertical | Vertical | 135 | A | C |
| | −45° | Hybrid | Hybrid | 75 | | |
| | −45° | Vertical | Vertical | 135 | | |
| Example 6 | +45° | Vertical | Vertical | 130 | B | B |
| | −45° | Hybrid | Hybrid | 85 | | |
| | −45° | Vertical | Vertical | 135 | | |
| Example 7 | +45° | Vertical | Vertical | 135 | A | A |
| | −45° | Hybrid | Hybrid | 75 | | |
| | −45° | Vertical | Vertical | 135 | | |
| Comparative | +45° | Vertical | Vertical | 135 | D | B |
| Example 1 | +45° | Vertical | Vertical | 135 | | |
| | −45° | Vertical | Vertical | 135 | | |

### Example 8

### Creation of Polarizing Plate AA

Using TD80UL (manufactured by Fujifilm Corporation, Re/Rth=2/40 at 550 nm) as a polarizing plate AA protective film AA, an alkaline saponification process was performed on the surface thereof. The film was soaked in a 1.5-regulated sodium hydroxide aqueous solution at 55° C. for 2 minutes, washed in a washing tub at room temperature, and neutralized using 0.1-regulatedsulfuric acid at 30° C. The film was washed in the washing tub once again and dried using warm air at 100° C.

Next, a roll-shaped polyvinyl alcohol film with a thickness of 80 μm was continuously stretched by a factor of 5 in an iodine aqueous solution and dried to obtain a polarizing film with a thickness of 20 μm. The saponification face of the alkaline saponification-processed TD80UL and the polyvinyl alcohol film were bonded together with an aqueous solution with 3% polyvinyl alcohol (PVA-117H manufactured by Kuraray Co., Ltd.) as an adhesive and the face of the transparent support A of the patterned optically anisotropic layer A and the polyvinyl alcohol film were bonded together using the adhesive to create a polarizing plate AA in which the TD80UL and the patterned optically anisotropic layer A are the protective film of the polarizing film. At this point, the angle between the slow axis of the phase difference film and the absorption axis of the polarizing film was ±45° and the stripes of the phase difference film and the absorption axis were parallel.

Finally, the polarizing plate AA and the polarizing plate A created in Example 1 were bonded together as illustrated in FIG. 7B. In particular, in Example 8, it was found that the Re's in the three regions were different, creating a product with a strong counterfeit prevention effect.

What is claimed is:

1. An optical film comprising:
a pattern optically anisotropic layer including at least a first phase difference region, a second phase difference region, and a third phase difference region, wherein the at least first phase difference region, second phase difference region, and third phase difference region are arranged in proximity with one another on a same plane,
an in-plane slow axis direction is different for the first phase difference region and the third phase difference region, and
in the second phase difference region, the in-plane slow axis direction is parallel to, and an in-plane retardation is different from, either the first phase difference region or the third phase difference region.

2. The optical film according to claim 1, further comprising:
a polarizing film.

3. The optical film according to claim 1,
wherein the pattern optically anisotropic layer is formed on a transparent support with an in-plane retardation Re (550) of 0 to 10 nm with a wavelength of 550 nm.

4. The optical film according to claim 1,
wherein the at least first phase difference region, second phase difference region, and third phase difference region are formed with a striped pattern.

5. The optical film according to claim 2,
wherein the at least first phase difference region, second phase difference region, and third phase difference region are formed with a striped pattern.

6. The optical film according to claim 5,
wherein an extending direction of the at least first phase difference region, second phase difference region, and third phase difference region with the striped pattern and an absorption axis of the polarizing film are parallel or orthogonal.

7. The optical film according to claim 2,
wherein the in-plane slow axis of the first phase difference region, the second phase difference region, and the third phase difference region and the absorption axis of the polarizing film respectively form an angle of ±45°.

8. The optical film according to claim 1,
wherein the in-plane retardations Re (550) with a wavelength of 550 nm of the first phase difference region and the third phase difference region are respectively 100 to 190 nm.

9. The optical film according to claim 1,
wherein the in-plane retardation Re (550) with a wavelength of 550 nm of the second phase difference region is 50 to 150 nm.

10. The optical film according to claim 1,
wherein the Re (550) of the second phase difference region and the slow axis direction of the second phase difference region are parallel, and a difference between Re's (550) of phase difference regions with different in-plane retardations is equal to or greater than 20 nm.

11. The optical film according to claim 1,
wherein any layer that configures the optical film contains an ultraviolet absorber.

12. The optical film according to claim 1,
wherein the first phase difference region, the second phase difference region, and the third phase difference region are respectively formed of a composition that includes a discotic liquid crystal compound with a polymerizable group.

13. The optical film according to claim 12,
wherein in at least one region of the first phase difference region, the second phase difference region, and the third phase difference region, an orientation of the discotic liquid crystal is fixed to a vertical orientation state.

14. The optical film according to claim 1,
wherein the pattern optically anisotropic layer is formed on an oriented film that is orientated in one direction.

15. The optical film according to claim 14,
wherein the oriented film is a rubbing oriented film that is rubbed in one direction.

16. A pair of polarizing films including two of the optical films according to claim 1.

17. A security product that uses the optical film according to claim 1.

18. A security product that includes at least two of the optical films according to claim 1 on one face or both faces of a transparent support, wherein out of the at least two optical films, at least one optical film is movable, and a light transmission amount can be adjusted according to a movement of the movable optical film.

19. An authenticity determination method which determines that a product that includes the security product according to claim 17 is genuine using a polarizing film and a product.
